(19) United States
(12) Patent Application Publication
(10) Pub. No.: US 2016/0336592 A1
(43) Pub. Date: Nov. 17, 2016

(54) NEGATIVE ELECTRODE FOR NON-AQUEOUS ELECTROLYTE SECONDARY BATTERY AND NON-AQUEOUS ELECTROLYTE SECONDARY BATTERY

(71) Applicant: SHIN-ETSU CHEMICAL CO., LTD., Tokyo (JP)

(72) Inventors: Takakazu HIROSE, Annaka (JP); Hiroki YOSHIKAWA, Takasaki (JP); Hiromichi KAMO, Takasaki (JP); Ken OHASHI, Setagaya-ku (JP)

(73) Assignee: SHIN-ETSU CHEMICAL CO., LTD., Tokyo (JP)

(21) Appl. No.: 15/112,574

(22) PCT Filed: Dec. 3, 2014
(86) PCT No.: PCT/JP2014/006040

§ 371 Date: Jul. 19, 2016

(30) Foreign Application Priority Data
Feb. 7, 2014 (JP) 2014-022151
Aug. 12, 2014 (JP) 2014-164368

(51) Int. Cl. H01M 4/36; H01M 4/587; H01M 4/133; H01M 4/58; H01M 10/0525; H01M 4/04; H01M 4/525; H01M 4/48

(52) U.S. Cl. CPC H01M 4/366; H01M 4/525; H01M 4/587; H01M 4/483; H01M 4/5825; H01M 10/0525; H01M 4/0404; H01M 4/133; H01M 2004/027

(57) ABSTRACT

The present invention provides a negative electrode for a non-aqueous electrolyte secondary battery, containing a plurality of negative electrode active materials including at least a silicon-based active material expressed by SiOₓ where 0.5≦x≦1.6 and a carbon-based active material, the silicon-based active material containing at least one of Li₂SiO₃ and Li₄SiO₄ therein, the silicon-based active material being coated with at least one of Li₂CO₃, LiF, and carbon, the silicon-based active material being included in an amount of 6 mass % or more with respect to a total amount of the negative electrode active materials. There can be provided a negative electrode that enables a lithium-ion secondary battery using this negative electrode to have improved cycle performance and initial charge and discharge performance and a lithium-ion secondary battery using this negative electrode.

### TECHNICAL FIELD

The present invention relates to a negative electrode for a non-aqueous electrolyte secondary battery and a non-aqueous electrolyte secondary battery.

### BACKGROUND ART

In recent years, small electronic devices, represented by mobile terminals, have been widely used and urgently required to reduce the size and weight and to increase the life. Such requirement has advanced the development of particularly small, lightweight secondary batteries with higher energy density.

These secondary batteries are considered to find application not only for small electronic devices but for large electronic devices such as, typically, automobiles as well as power storage systems such as, typically, houses.

Among those, lithium-ion secondary batteries are easy to reduce the size and increase the capacity and have higher energy density than those of lead or nickel-cadmium batteries, receiving considerable attention.

The lithium-ion secondary battery has positive and negative electrodes, a separator, and an electrolyte. The negative electrode includes a negative electrode active material related to charging and discharging reactions.

The negative electrode active material, which is usually made of a carbon material, is required to further improve the battery capacity for recent market requirement.

Use of silicon as a negative electrode active material is considered to improve the battery capacity, for silicon has a logical capacity (4199 mAh/g) ten times larger than does graphite (372 mAh/g). Such a material is thus expected to significantly improve the battery capacity.

The development of silicon materials for use as negative electrode active materials includes not only silicon as a simple but also alloy thereof and a compound thereof such as typically oxides.

The consideration of active material shapes for carbon materials ranges from a standard application type to an integrated type in which the materials are directly accumulated on a current collector.

Use of silicon as a main material of a negative electrode active material, however, expands or shrinks the negative electrode active material when charging or discharging, thereby making the negative electrode active material easy to break particularly near its surface layer. In addition, this active material produces ionic substances in its interior and is thus easy to break.

The breakage of the surface layer of the negative electrode active material creates a new surface, increasing a reaction area of the active material. The new surface then causes the decomposition reaction of an electrolyte and is coated with a decomposition product of the electrolyte, thereby consuming the electrolyte. This makes the cycle performance easy to reduce.

Various materials and configurations of a negative electrode for a lithium-ion secondary battery mainly using a silicon material have been considered to improve the initial efficiency and the cycle performance of the battery.

More specifically, a vapor deposition method is used to accumulate silicon and amorphous silicon dioxide simultaneously so that better cycle performance and greater safety are achieved (See Patent Document 1, for example).

Moreover, a carbon material, an electronic conduction material, is disposed on the surface of silicon oxide particles so that higher battery capacity and greater safety are achieved (See Patent Document 2, for example).

Moreover, an active material including silicon and oxygen is produced to form an active material layer having a higher ratio of oxygen near a current collector so that improved cycle performance and higher input-output performance are achieved (See Patent Document 3, for example).

Moreover, silicon active material is formed so as to contain oxygen with an average content of 40 at % or less and with a higher oxygen content near a current collector so that improved cycle performance is achieved (See Patent Document 4, for example).

Moreover, a nano-complex including Si-phase, SiO₂, M_{y}O metal oxide is used to improve the first charge and discharge efficiency (See Patent Document 5, for example).

Moreover, SiOₓ (0.8≦x≦1.5) having a particle size ranging from 1 μm to 50 μm and a carbon material are mixed and calcined at a high temperature so that improved cycle performance is achieved (See Patent Document 6, for example).

Moreover, a mole ratio of oxygen to silicon in a negative electrode active material is adjusted in the range from 0.1 to 1.2 so as to hold a difference between the maximum and the minimum of the mole ratio near the interface between the active material and a current collector at 0.4 or less, so that improved cycle performance is achieved (See Patent Document 7, for example).

Moreover, a metal oxide containing lithium is used to improve the battery load characteristic (See Patent Document 8, for example).

Moreover, a hydrophobic layer such as a silane compound is formed in the surface layer of a silicon material so that improved cycle performance is achieved (See Patent Document 9, for example).

Moreover, a silicon oxide is used and coated with graphite to give conductivity so that improved cycle performance is achieved (See Patent Document 10, for example). Patent Document 10 describes that a shift value of the graphite coating, which is obtained from a Raman spectrum, has broad peaks at 1330 cm⁻¹ and 1580 cm⁻¹ and a ratio I₁₃₃₀/I₁₅₈₀ of its intensity shows 1.5<I₁₃₃₀/I₁₅₈₀<3.

Moreover, a particle having an Si-microcrystal phase dispersing in a silicon dioxide is used to achieve higher battery capacity and improved cycle performance (See Patent Document 11, for example).

Moreover, a silicon oxide having a silicon-to-oxygen atomicity ratio of 1:y (0<y<2) is used to improve overcharge and overdischarge performance (See Patent Document 12, for example).

Finally, a mixed electrode containing silicon and carbon with a silicon content of 5 wt % to 13 wt % is produced to achieve higher battery capacity and improved cycle performance (See Patent Document 13, for example).

### CITATION LIST

### Patent Literature

Patent Document 1: Japanese Unexamined Patent publication (Kokai) No. 2001-185127
Patent Document 2: Japanese Unexamined Patent publication (Kokai) No. 2002-042806
Patent Document 3: Japanese Unexamined Patent publication (Kokai) No. 2006-164954
Patent Document 4: Japanese Unexamined Patent publication (Kokai) No. 2006-114454
Patent Document 5: Japanese Unexamined Patent publication (Kokai) No. 2009-070825
Patent Document 6: Japanese Unexamined Patent publication (Kokai) No. 2008-282819
Patent Document 7: Japanese Unexamined Patent publication (Kokai) No. 2008-251369
Patent Document 8: Japanese Unexamined Patent publication (Kokai) No. 2008-177346
Patent Document 9: Japanese Unexamined Patent publication (Kokai) No. 2007-234255
Patent Document 10: Japanese Unexamined Patent publication (Kokai) No. 2009-212074
Patent Document 11: Japanese Unexamined Patent publication (Kokai) No. 2009-205950
Patent Document 12: Japanese Patent No. 2997741
Patent Document 13: Japanese Unexamined Patent publication (Kokai) No. 2010-092830

### SUMMARY OF INVENTION

### Technical Problem

As described previously, small electronic devices, represented by mobile terminals, have been developed to improve their performance and increase their functions. Lithium-ion secondary batteries, which are used as main sources of the devices, have been required to increase the battery capacity.

The development of lithium-ion secondary batteries including negative electrodes mainly using silicon materials have been desired to solve this problem.

The lithium-ion secondary batteries using silicon materials need the same cycle performance as lithium-ion secondary batteries using carbon materials.

However, no one hag yet proposed a negative electrode for this type of batteries that have the same cyclic stability as the lithium-ion secondary batteries using carbon materials.

The present invention was accomplished in view of the above problems, and an object thereof is to provide a negative electrode that can increase the battery capacity and improve the cycle performance and initial charge and discharge performance, as well as a non-aqueous electrolyte secondary battery including this negative electrode.

### Solution to Problem

To achieve this object, the present invention provides a negative electrode for a non-aqueous electrolyte secondary battery, comprising a plurality of negative electrode active materials including at least a silicon-based active material expressed by SiOₓ where 0.5≦x≦1.6 and a carbon-based active material, the silicon-based active material containing at least one of Li₂SiO₃ and Li₄SiO₄ therein, the silicon-based active material being coated with at least one of Li₂CO₃, LiF, and carbon, the silicon-based active material being included in an amount of 6 mass % or more with respect to a total amount of the negative electrode active materials.

A carbon material can be discharged to lower potential. Thus, such a negative electrode, in which a silicon-based active material and a carbon-based active material are mixed, enables a battery using this negative electrode to have an improved volume energy density. Moreover, in the silicon-based active material, a SiO₂ component part, which is destabilized with insertion and extraction of lithium, is previously modified into a lithium compound. This allows reduction in irreversible capacity generated at charging. Furthermore, battery performances can be improved by coating the silicon-based active material with Li₂CO₃, LiF, which have high water resistance, or carbon, which can increase the conductivity. Furthermore, although a silicon material is generally discharged to higher potential than does a carbon material, when the silicon-based active material is included in the negative electrode active materials in an amount of 6 mass % or more, the volume energy density of the battery can be improved.

The negative electrode active materials preferably have a volume density of 0.75 g/cc or more and 1.38 g/cc or less at charging.

When the volume density is in this range, the volume energy density is prevented from decreasing in the negative electrode.

The negative electrode for a non-aqueous electrolyte secondary battery preferably further comprises a carbon nanotube.

Carbon nanotube (CNT) is suited to achieve an electric contact between the carbon-based active material and the silicon-based active material having high expansion and contraction rates, enabling the negative electrode to have good conductivity.

The carbon-based active material preferably includes at least two of natural graphite, synthetic graphite, hard carbon, and soft carbon.

When at least two or more of them are included, good battery performances can be achieved.

The carbon-based active material preferably includes natural graphite in an amount of 30 mass % or more and 80 mass % or less with respect to a total weight of the carbon-based active material.

Natural graphite is suited to relax a stress due to expansion and contraction of the silicon material and then prevents the negative electrode active material from breaking, thus providing good cycle performance.

A median size X of the carbon-based active material and a median size Y of the silicon-based active material preferably satisfy X/Y≧1.

When the silicon-based active material, which may expand or contract, is equal to or smaller than the carbon-based active material, breakage of the mixture layer can be prevented. In addition, when the carbon-based active material is larger than the silicon-based active material, the volume density of the negative electrode at charging, the initial efficiency, and thus the battery energy density are improved.

The silicon-based active material preferably satisfies A/B≧0.8 where A is a peak intensity of an Si region represented by a chemical shift value of −60 ppm to −100 ppm and B is a peak intensity of an SiO₂ region represented by a chemical shift value of −100 ppm to −150 ppm, the chemical shift value being obtained from a ²⁹Si-MAS-NMR spectrum.

Use of the silicon-based active material having the above peak intensity ratio enables better initial charge and discharge performance.

Li₂SiO₃ contained inside the silicon-based active material preferably exhibits a diffraction peak having a half width (2θ) of 0.75° or more, the diffraction peak appearing around 38.2680° and obtained by X-ray diffraction.

When Li₂SiO₃ contained inside the silicon-based active material has low crystallinity, degradation of the battery performances can be reduced.

Li₄SiO₄ contained inside the silicon-based active material preferably exhibits a diffraction peak having a half width (2θ) of 0.2° or more, the diffraction peak appearing around 23.9661° and obtained by X-ray diffraction.

When Li₄SiO₄ contained inside the silicon-based active material has low crystallinity, degradation of the battery performances can be reduced.

Li₂SiO₃ and Li₄SiO₄ contained inside the silicon-based active material are preferably amorphous.

When these lithium compounds are amorphous, degradation of the battery performances can be reduced more surely.

The silicon-based active material preferably exhibits a diffraction peak having a half width (2θ) of 1.2° or more, the diffraction peak being attributable to an Si(111) crystal face and obtained by X-ray diffraction, and a crystallite size attributable to the crystal face is 7.5 nm or less.

Such a silicon-based active material contains less Si-crystal nuclei, providing good battery cycle performance.

Furthermore, the present invention provides a non-aqueous electrolyte secondary battery comprising the above negative electrode and a positive electrode containing a positive electrode active material of lithium cobaltate, wherein the negative electrode has a discharge cutoff voltage of 0.35 V or more and 0.85 V or less when a battery cutoff voltage is 3 V.

When the cutoff voltage of the negative electrode is 0.85 V or less in the battery that includes the positive electrode containing a positive electrode active material of lithium cobaltate, a coating component produced on the negative electrode can be prevented from partially peeling and dissolving so that cycle performances of the battery can be improved. When the cutoff voltage of the negative electrode is 0.35 V or more, the volume energy density increases so that the battery capacity can be easily improved.

Furthermore, the present invention provides a non-aqueous electrolyte secondary battery comprising the above negative electrode and a positive electrode containing a positive electrode active material of a lithium nickel cobalt complex oxide, wherein the negative electrode has a discharge cutoff voltage of 0.39 V or more and 1.06 V or less when a battery cutoff voltage is 2.5 V.

When the cutoff voltage of the negative electrode is 1.06 V or less in the battery that includes the positive electrode containing a positive electrode active material of a lithium nickel cobalt complex oxide, a coating component produced on the negative electrode can be prevented from partially peeling and dissolving so that cycle performances of the battery can be improved. When the cutoff voltage of the negative electrode is 0.39 V or more, the volume energy density increases so that the battery capacity can be easily improved.

In this battery, the lithium nickel cobalt complex oxide is preferably a lithium nickel cobalt aluminum complex oxide or a lithium nickel cobalt manganese complex oxide.

Such materials can be suitably used as the positive electrode active material of the inventive non-aqueous electrolyte secondary battery.

A utilization factor of the negative electrode is preferably 93% or more and 99% or less.

The battery having a negative electrode utilization factor of 93% or more prevents reduction in the first charge efficiency and greatly improves the battery capacity; one having a negative electrode utilization factor of 99% or less prevents the precipitation of lithium, thereby ensuring safety.

To achieve the above object, the present invention further provides a method of producing a negative electrode for a non-aqueous electrolyte secondary battery, the negative electrode containing a negative electrode active material and a metallic current collector, the method comprising: preparing, as the negative electrode active material, a carbon-based active material and an unmodified silicon-based active material expressed by SiOₓ where 0.5≦x≦1.6; forming a mixture slurry of the carbon-based active material and the unmodified silicon-based active material that have been prepared; applying the formed mixture slurry to the metallic current collector; and after applying, modifying the silicon-based active material in the mixture slurry applied to the metallic current collector by at least one of a Li metal-sticking method, a Li vapor deposition method, and an electrochemical method.

In this manner, a negative electrode that exhibits better battery performances when used for a non-aqueous electrolyte secondary battery can be produced by modifying the silicon-based active material applied and thereby formed on the metallic current collector by at least one of a Li metal-sticking method, a Li vapor deposition method, and an electrochemical method. Such a producing method can produce the inventive negative electrode for a non-aqueous electrolyte secondary battery.

Furthermore, the present invention provides a negative electrode for a non-aqueous electrolyte secondary battery produced by this method.

The negative electrode produced by this method exhibits better battery performances when used for a non-aqueous electrolyte secondary battery.

### Advantageous Effects of Invention

In the silicon-based active material of the inventive negative electrode for a non-aqueous electrolyte secondary battery, a SiO₂ component part, which is destabilized with insertion and extraction of lithium, is previously modified into another compound. This allows reduction in irreversible capacity generated at charging.

Moreover, mixing the silicon-based active material with the carbon-based active material enables the battery capacity to increase. Furthermore, when the silicon-based active material is included in an amount of 6 mass % or more with respect to the total amount of the negative electrode active materials, the battery capacity can be improved surely.

The inventive negative electrode for a non-aqueous electrolyte secondary battery using the negative electrode material and a non-aqueous electrolyte secondary battery using this negative electrode can improve the battery capacity, cycle performance, and first charge and discharge performance. In addition, electronic devices, machine tools, electric vehicles, and power storage systems, etc., using the inventive secondary battery also can achieve the same effect.

### BRIEF DESCRIPTION OF DRAWINGS

FIG. 1 is a cross-sectional view showing an exemplary configuration of the inventive negative electrode for a non-aqueous electrolyte secondary battery;

FIG. 2 shows a bulk modification apparatus used in production of negative electrode active materials contained in the inventive negative electrode for a non-aqueous electrolyte secondary battery;

FIG. 3 is a diagram showing an exemplary configuration of a lithium secondary battery of laminate film type containing the inventive negative electrode; and

FIG. 4 is a graph showing an increase rate of the battery capacity when the content of the silicon-based active material is increased in the negative electrode active materials.

### DESCRIPTION OF EMBODIMENTS

Hereinafter, embodiments of the present invention will be described, but the present invention is not limited thereto.

As described previously, use of a negative electrode mainly made of a silicon material, for use in a lithium-ion secondary battery, has been considered to increase the capacity of the lithium-ion secondary battery.

The lithium-ion secondary battery using a silicon material is required to have the same cycle performance as a lithium-ion secondary battery using a carbon material; however, no one has yet proposed a negative electrode for this type of battery having the same cycle stability as a lithium-ion secondary battery using a carbon material.

In view of this, the present inventors diligently conducted study on a negative electrode active material that allows a lithium-ion secondary battery using a negative electrode containing this material to have good cycle performance, bringing the present invention to completion.

The inventive negative electrode for a non-aqueous electrolyte secondary battery contains a silicon-based active material (SiOₓ where 0.55≦x≦1.6) and a carbon-based active material. The silicon-based active material contains at least one of Li₂SiO₃ and Li₄SiO₄ in its interior and is coated with at least one of Li₂CO₃, LiF, and carbon. Additionally, the silicon-based active material is included in an amount of 6 mass % or more with respect to the total amount of the negative electrode active materials.

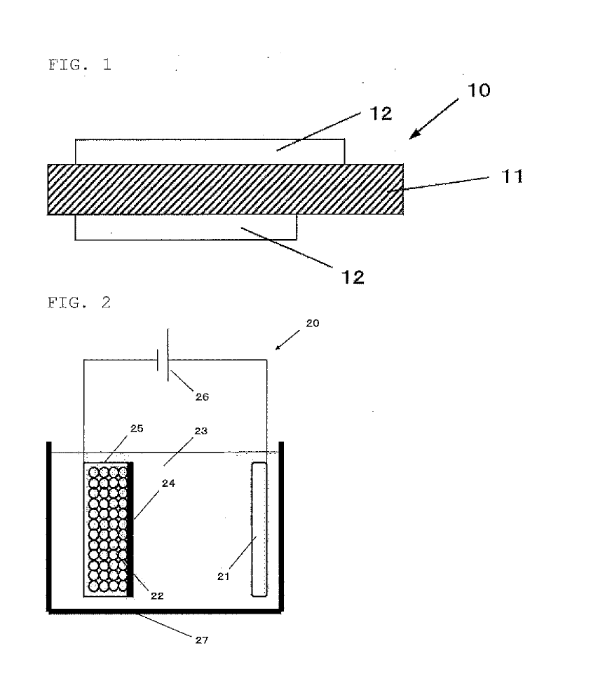

Hereinafter, the inventive negative electrode for a non-aqueous electrolyte secondary battery using the negative electrode active materials will be described. FIG. 1 is a cross-sectional view of a configuration of a negative electrode for a non-aqueous electrolyte secondary battery (also simply referred to as a “negative electrode” below) according to an embodiment of the invention.

### [Configuration of Negative Electrode]

As shown in FIG. 1, the negative electrode 10 has a negative electrode active material layer 12 on a negative electrode current collector 11. The negative electrode active material layer 12 may be disposed on one side or both sides of the negative electrode current collector 11. The negative electrode current collector 11 is not necessarily needed in the inventive negative electrode using the negative electrode active materials.

### [Negative Electrode Current Collector]

The negative electrode current collector 11 is made of a highly conductive and mechanically strong material. Examples of the conductive material used for the negative electrode current collector 11 include copper (Cu) and nickel (Ni). Such conductive materials preferably have inability to form an intermetallic compound with lithium (Li).

The negative electrode current collector 11 preferably contains carbon (C) and sulfur (S) besides the main element since these elements improve the physical strength of the current collector. In particular, when the active material layer contains a material expandable at charging, the current collector including the above elements can inhibit deformation of the electrodes and the current collector itself. The amount of the contained elements is preferably, but not particularly limited to, 100 ppm or less. This amount enables effective inhibition of the deformation.

The surface of the negative electrode current collector 11 may or may not be roughed. Examples of the negative electrode current collector roughened include a metallic foil subjected to an electrolyzing process, an embossing process, or a chemical etching process. Examples of the negative electrode current collector that is not roughened include a rolled metallic foil.

### [Negative Electrode Active Material Layer]

The negative electrode active material layer 12 contains particulate negative electrode materials (hereinafter, also referred to as negative electrode active material particles) that can occlude and emit lithium ions and may further contain other materials such as a negative-electrode binder or a conductive additive depending on battery design.

The negative electrode active materials used in the inventive negative electrode include a silicon-based active material and a carbon-based active material. The silicon-based active material contains a silicon compound that can occlude and emit lithium ions and a lithium compound on the surface or in the interior of the silicon compound. The silicon-based active material is further coated with at least one of Li₂CO₃, LiF, and carbon.

As described previously, the silicon-based active material particle has a core that can occlude and emit lithium ions, and the core is coated with at least one of a carbon coating portion, which provides conductivity, a fluorinated lithium portion and a lithium carbonate portion, which have an effect of inhibiting the decomposition reaction of an electrolyte. Lithium ions may be occluded and emitted also in at least a part of the carbon coating portion. The carbon coating portion, the fluorinated lithium portion, and the lithium carbonate portion exhibit the effect in either form of an island form and a film form.

The silicon-based active material (SiOₓ, where 0.55≦x≦1.6) used in the inventive negative electrode is a silicon oxide; a preferable composition of the silicon oxide is that x is close to 1. The reason is that this composition enables high cycle performance. The present invention does not necessarily intend a silicon material composition of 100% but permits a silicon material containing a minute amount of impurities.

The silicon-based active material contains at least one of Li₂SiO₃ and Li₄SiO₄ inside its particle and coated with at least one of Li₂CO₃, LiF, and carbon.

This structure yields stable battery performances.

Such a silicon-based active material can be obtained by selectively modifying a part of the SiO₂ components formed therein into a lithium compound. Above all, Li₄SiO₄ and Li₂SiO₃ have especially good performances. These selective compounds can be formed by potential control or current control relative to a lithium counter electrode under various conditions.

The lithium compound can be quantified by NMR (Nuclear Magnetic Resonance) and XPS (X-ray Photoelectron Spectroscopy). XPS and NMR measurements can be performed, for example, under the following conditions.

### XPS

Apparatus: an X-ray photoelectron spectroscopy apparatus
X-ray Source: a monochromatic Al-Kα ray
X-ray Spot Diameter: 100 μm
Ar-ion Sputtering Gun Conditions: 0.5 kV, 2 mm×2 mm

### ²⁹Si-MAS-NMR

Apparatus: a 700-NMR spectroscope made by Bruker Corp.
Probe: a 4-mm-HR-MAS rotor, 50 μL
Sample Rotation Speed: 10 kHz
Temperature of Measurement Environment: 25° C.

The production of the selective compound, i.e., the modification of the silicon-based active material is preferably performed in an electrochemical manner.

Such modification (bulk modification) to produce the negative electrode active material particles enables reduction or prevention of the lithium compound formation in an Si region, stabilizing the material in the air, water slurry, or solvent slurry. Moreover, electrochemical modification can produce a more stable substance than thermal modification (thermal doping method), in which the compound is randomly modified.

Li₄SiO₄ and Li₂SiO₃ can improve the performance when at least one of them is formed within a bulk of the silicon-based active material, and the combination thereof can further improve the performance.

Moreover, formation of Li₂CO₃ and a fluorine compound such as LiF on the outermost surface of the silicon-based active material dramatically improves the powder storage property. In particular, these compounds are preferably formed with a coverage of 30% or more. The most preferable material is LiF and Li₂CO₃, and the most preferable forming method is an electrochemical method, though not particularly limited thereto.

In particular, Li₂SiO₃ contained inside the silicon-based active material preferably exhibits a diffraction peak having a half width (2θ) of 0.75° or more that appears around 38.26800 and is obtained by X-ray diffraction. Additionally, Li₄SiO₄ contained inside the silicon-based active material preferably exhibits a diffraction peak having a half width (2θ) of 0.2° or more that appears around 23.9661° and is obtained by X-ray diffraction. Li₂SiO₃ and Li₄SiO₄ contained inside the silicon-based active material are more preferably amorphous.

The lithium compounds contained inside the silicon-based active material with lower crystallinity can reduce electrical resistance in the negative electrode materials, thus reducing degradation of the battery performances. When these compounds are substantially amorphous, degradation of the battery performances can be reduced more surely.

In the prevent invention, the negative electrode material is a mixture of the silicon-based active material and the carbon-based active material. The carbon material, which can be discharged to lower potential, enables improvement in the volume energy density.

The carbon-based active material contained in the negative electrode is preferably mainly made of natural graphite. More specifically, the carbon-based active material preferably includes natural graphite in an amount of 30 mass % or more and 80 mass % or less with respect to the total weight of the carbon-based active material.

Natural graphite is suited to relax a stress due to expansion and contraction of the silicon material. The above content ratio thus allows the negative electrode to have excellent cycle performance.

To achieve more excellent cycle performance, synthetic graphite is preferably included. However, synthetic graphite is hard and unsuited to relax a stress due to expansion and contraction of the silicon material, compared with natural graphite. The adding amount thereof is preferably 10% or more and 120% or less with respect to natural graphite.

Moreover, the carbon-based active material contained in the negative electrode preferably includes at least two of natural graphite, synthetic graphite, hard carbon, and soft carbon.

When at least two or more of them are included, the negative electrode material has stress relaxation effect and is excellent in the battery capacity.

In the present invention, the silicon-based active material is included in an amount of 6 mass % or more with respect to the total amount of the negative electrode active materials. Moreover, battery efficiency of the silicon material alone is preferably 75% or more.

Even when the silicon-based active material which has low initial efficiency and is discharged to higher potential than the carbon-based active material is used, a battery containing the above amount or more of the silicon-based active material can increase its volume energy density.

A lower crystallinity of the silicon-based active material contained in the inventive negative electrode is better. More specifically, the silicon-based active material preferably exhibits a diffraction peak having a half width (2θ) of 1.2° or more that is attributable to an Si(111) crystal face and obtained by X-ray diffraction, and a crystallite size attributable to the crystal face is 7.5 nm or less. Use of the silicon-based active material with low crystallinity, which has a few Si crystal, can improve the battery performances and allows production of a stable lithium compound.

The median size of the silicon-based active material preferably ranges from 0.5 μm to 20 μm, but not particularly limited thereto. This range makes it easy to occlude and emit lithium ions and inhibits the breakage of the particles at charging and discharging. A median size of 0.5 m or more then prevents the silicon compound surface from increasing and can thus reduce the battery irreversible capacity; a median size of 20 μm or less inhibits the breakage of the particles and the creation of a new surface, so that this range is preferable.

The median size of the silicon-based active material preferably satisfies X/Y≧1 where X is the median size of the carbon-based active material and Y is the median size of the silicon-based active material.

In brief, the carbon-based active material in the negative electrode material layer is preferably equal to or larger than the silicon-based active material. When the silicon-based active material, which may expand or contract, is equal to or smaller than the carbon-based active material, breakage of the mixture layer can be prevented. In addition, when the carbon-based active material is larger than the silicon-based active material, the volume density of the negative electrode at charging, the initial efficiency, and thus the battery energy density are improved.

The silicon-based material in the negative electrode materials preferably satisfies A/B≧0.8 where A is a peak intensity of an Si region represented by a chemical shift value of −60 ppm to −100 ppm and B is a peak intensity of an SiO₂ region represented by a chemical shift value of −100 ppm to −150 ppm, as obtained from a ²⁹Si-MAS-NMR spectrum.

This ratio enables stable battery performances.

If the silicon-based active material is coated with carbon, this carbon coating portion preferably has an average thickness of 1 nm to 5000 nm, although not particularly limited thereto.

This thickness enables improvement in electrical conductivity. The carbon coating portion with an average thickness exceeding 5000 nm does not degrade the battery performance, but reduces the battery capacity. Thus, the thickness is preferably 5000 nm or less.

The average thickness of the carbon coating portion is calculated in the following manner. First, the negative electrode active material is observed by a transmission electron microscope (TEM) with an appropriate magnification. The magnification is preferably such that the thickness can be visually checked and measured. Then, the thickness of the carbon coating portion is measured at 15 arbitrary points. At this time, the measurement points are preferably distributed at random as widely as possible without concentrating in a certain area. Finally, an average value is calculated form the measurement results.

The coverage of the carbon material on the silicon-based active material is preferably as high as possible although there is no particular limitation. Especially when the coverage is 30% or more, the electrical conductivity is appropriate.

The coating method with the carbon material is preferably, but not particularly limited to, sugar carbonization or pyrolysis of hydrocarbon gas, for these methods can improve the coverage.

The negative-electrode binder may be, for example, one or more of a polymer material and a synthetic rubber. Examples of the polymer material include polyvinylidene fluoride, polyimide, polyamideimide, aramid, polyacrylic acid, lithium polyacrylate, and carboxymethyl cellulose. Examples of the synthetic rubber include a styrene-butadiene rubber, a fluorinated rubber, and an ethylene-propylene-diene.

Examples of the negative-electrode conductive additive include carbon materials such as carbon black, acetylene black, graphite, ketjen black, carbon nanotube (CNT), carbon nanofiber, and the combination thereof.

In particular, carbon nanotube is suited to achieve an electric contact between the carbon material and the silicon material having high expansion and contraction rates.

The negative electrode active material layer is formed by, for example, an application method. The application method is to mix the negative electrode active material particles and the binders, in addition to the conductive additive and the carbon material as needed, and disperse the resultant mixture into an organic solvent or water to apply the resultant to a subject.

### [Method of Producing Negative Electrode]

First, the method of producing the negative electrode active material particles contained in the negative electrode material for a non-aqueous electrolyte secondary battery will be now described. The method begins with a production of a silicon-based active material expressed by SiOₓ (0.5≦x≦1.6). The silicon-based active material is then modified by inserting lithium into the silicon-based active material and thereby forming a lithium compound on its surface, in its interior, or both of them.

More specifically, the negative electrode active material particles can be produced by, for example, the following procedure.

A raw material capable of generating a silicon oxide gas is first heated under an inert gas atmosphere or a reduced pressure at a temperature ranging from 900° C. to 1600° C. to produce the silicon oxide gas. The raw material is a mixture of metallic silicon powder and silicon dioxide powder. The mole ratio of the mixture preferably satisfies the relation of 0.8<metallic silicon powder/silicon dioxide powder<1.3, in consideration of the existence of oxygen on the metallic silicon powder surface and a minute amount of oxygen in a reactor. The Si-crystallites in the particles are controlled by adjustment of an arrangement range and a vaporization temperature, or heat treatment after the production. The produced gas is deposited on an adsorption plate. The temperature in the reactor is decreased to 100° C. or less and then a deposit is taken out. The deposit is pulverized with a ball mill or a jet mill to form powder.

The obtained powder material may be coated with a carbon layer although this step is not essential.

Thermal CVD is desirably used to coat the obtained powder material with the carbon layer. This thermal CVD is to fill a furnace in which the silicon oxide powder is placed with a hydrocarbon gas and heat the interior of the furnace. The pyrolysis temperature is preferably, but not particularly limited to, 1200° C. or less, more preferably 950° C. or less. This temperature range enables the inhibition of an unintended disproportionation of the active material particles. The hydrocarbon gas preferably has a composition of CₙHₘ where 3≧n, though not particularly limited thereto, for this composition enables reduction in production cost and improvement in physical properties of a pyrolysis product.

The bulk modification is preferably performed by inserting and extracting lithium in the electrochemical manner. Although apparatus structure is not particularly limited, bulk modification can be performed with, for example, a bulk modification apparatus 20 shown in FIG. 2. The bulk modification apparatus 20 shown in FIG. 2 includes a bath 27 filled with an organic solvent 23, a positive electrode 21 (lithium source) provided within the bath 27 and connected to one terminal of a power source 26, a powder storage container 25 provided within the bath 27 and connected to the other terminal of the power source 26, and a separator 24 provided between the positive electrode 21 and the powder storage container 25. In the powder storage container 25, silicon oxide powder 22 is stored.

The modified silicon oxide powder 22 is then coated with at least one of Li₂CO₃, LiF, and carbon to form a coating layer.

In the bulk modification treatment, when a fluorine compound is formed on the surface, the fluorine compound is preferably formed by changing potential and temperature conditions. This yields a dense film. Especially when fluorinated lithium is formed, it is preferable to keep the temperature at 45° C. or higher during insertion and extraction of lithium.

As described previously, the modified particles thus obtained may contain no carbon layer. However, when more uniform control is required in the bulk modification treatment, electrical potential distribution needs to be reduced, and thus the carbon layer is desirably contained.

Examples of the organic solvent 23 in the bath 27 include ethylene carbonate, propylene carbonate, dimethyl carbonate, diethyl carbonate, ethylmethyl carbonate, fluoromethylmethyl carbonate, and difluoromethylmethyl carbonate. Examples of electrolyte salt contained in the organic solvent 23 include lithium hexafluorophosphate (LiPF₆) and lithium tetrafluoroborate (LiBF₄).

The positive electrode 21 may use a lithium foil or a Li-containing compound. Examples of the Li-containing compound include lithium carbonate, lithium oxide, lithium cobaltate, olivine iron lithium, lithium nickelate, and lithium vanadium phosphate.

Subsequently, the silicon-based active material and the carbon-based active material are mixed, and the negative electrode active material particles are mixed with the negative-electrode binder and other materials such as conductive additives. The resultant negative electrode mixture is then mixed with an organic solvent, water or the like to form slurry.

The mixture slurry is then applied to the surface of the negative-electrode current collector and dried to form a negative electrode active material layer 12 shown in FIG. 1. At this time, heating press may be performed, if necessary.

In this negative electrode, the SiO₂ component in the bulk is modified into a stable lithium compound, a lithium compound and lithium carbonate is formed as a surface protecting layer, and the silicon-based active material is included in an amount of 6 mass % or more with respect to the total amount of the negative electrode materials. Such a negative electrode can improve the battery initial efficiency and stability of the active material with cycle performance.

In a non-aqueous electrolyte secondary battery using the inventive negative electrode, when lithium cobaltate is used for a positive electrode active material contained in the positive electrode with a battery cutoff voltage of 3.0 V, the battery efficiency of the silicon-based active material in the negative electrode is preferably controlled to 75% or more to achieve a cutoff voltage of the negative electrode of 0.85 V or less in battery design.

When the cutoff voltage of the negative electrode is 0.85 V or less, a coating component produced on the negative electrode can be prevented from partially peeling and dissolving so that the cycle performance of the battery can be improved.

In this battery, the cutoff voltage of the negative electrode is preferably 0.35 V or more to improve the battery capacity.

When the cutoff voltage of the negative electrode is 0.35 V or more, the volume energy density increases so that the battery capacity can be easily improved.

In a non-aqueous electrolyte secondary battery using the inventive negative electrode, when a lithium nickel cobalt complex oxide is used for a positive electrode active material contained in the positive electrode with a battery cutoff voltage of 2.5 V, the battery efficiency of the silicon-based active material in the negative electrode is preferably controlled to 75% or more to achieve a cutoff voltage of the negative electrode of 1.06 V or less in battery design.

When the cutoff voltage of the negative electrode is 1.06 V or less, a coating component produced on the negative electrode can be prevented from partially peeling and dissolving so that the cycle performance of the battery can be improved.

In this battery, the cutoff voltage of the negative electrode is preferably 0.39 V or more to improve the battery capacity.

When the cutoff voltage of the negative electrode is 0.39 V or more, the volume energy density increases so that the battery capacity can be easily improved.

The lithium nickel cobalt complex oxide is preferably a lithium nickel cobalt aluminum complex oxide (NCA) or a lithium nickel cobalt manganese complex oxide (NCM).

The negative electrode active material in the negative electrode active material layer preferably has a volume density of 0.75 g/cc or more and 1.38 g/cc or less at charging. A volume density of 0.75 g/cc or more increases the volume energy density of the negative electrode. A volume density of 1.38 g/cc or less prevents lack of the silicon-based active material and thus prevents volume energy density (Wh/l) of the battery from significantly decreasing, compared with the case of using a negative electrode material consisting of a carbon-based active material alone.

### <2. Lithium-Ion Secondary Battery>

A lithium-ion secondary battery will now be described for an illustrative example of the non-aqueous electrolyte secondary battery using the above negative electrode.

### [Configuration of Laminate Film Secondary Battery]

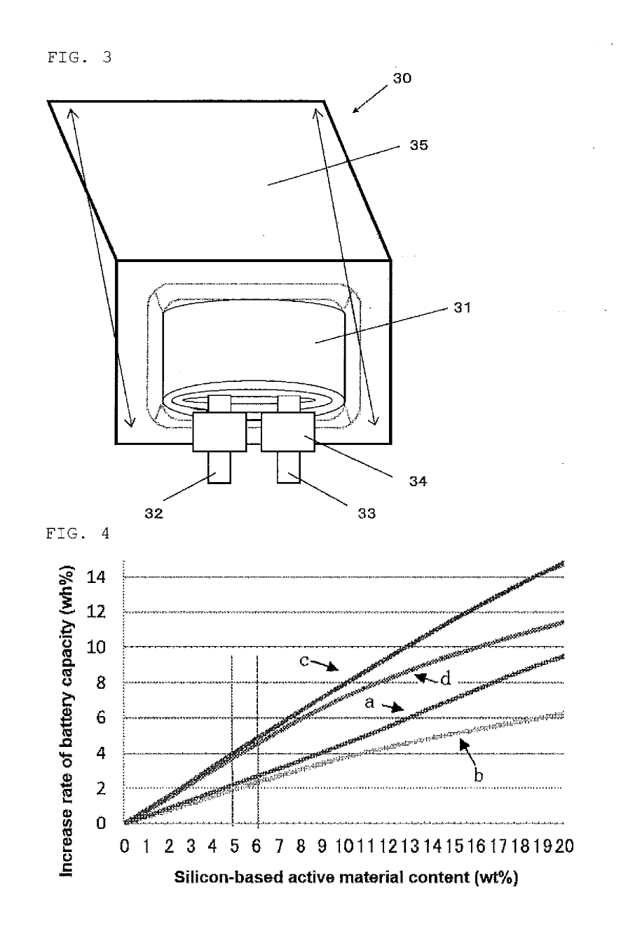

The laminate film secondary battery 30 shown in FIG. 3 includes a wound electrode body 31 interposed between sheet-shaped outer parts 35. The wound electrode body are formed by winding a positive electrode, a negative electrode, and a separator disposed between these electrodes. The electrode body may also be composed of a laminated part of the positive and negative electrodes, and a separator disposed between these electrodes. The electrode bodies of both types have a positive-electrode lead 32 attached to the positive electrode and a negative-electrode lead 33 attached to the negative electrode. The outermost circumference of the electrode body is protected by a protecting tape.

The positive-electrode lead and the negative-electrode lead, for example, extends from the interior of the outer parts 35 toward the exterior in one direction. The positive-electrode lead 32 is made of, for example, a conductive material such as aluminum; the negative-electrode lead 33 is made of, for example, a conductive material such as nickel or copper.

An example of the outer part 35 is a laminate film composed of a fusion-bond layer, a metallic layer, and a surface protecting layer stacked in this order. Two laminate films are fusion-bonded or stuck with an adhesive at the outer edge of their fusion-bond layers such that each fusion-bond layer faces the electrode body 31. The fusion-bond layer may be, for example, a film such as a polyethylene or polypropylene film; the metallic layer aluminum foil; the protecting layer nylon.

The space between the outer parts 35 and the positive and negative electrodes is filled with close adhesion films 34 to prevent air from entering therein. Exemplary materials of the close adhesion films include polyethylene, polypropylene, and polyolefin.

### [Positive Electrode]

The positive electrode has a positive electrode active material layer disposed on one side or both sides of a positive electrode current collector as in the negative electrode 10, for example, shown in FIG. 1.

The positive electrode current collector is made of, for example, a conductive material such as aluminum.

The positive electrode active material layer contains a positive electrode material that can occlude and emit lithium ions or the combination thereof, and may contain a binder, a conductive additive, a dispersing agent, or other materials according to design. The same detailed description as described for the negative electrode binders and negative electrode conductive additive, for example, is then given for this binder and this conductive additive.

The positive electrode material is preferably a compound containing lithium. Examples of this compound include a complex oxide composed of lithium and transition metal elements, and a phosphoric acid compound containing lithium and transition metal elements. Among them, a compound containing at least one of nickel, iron, manganese, and cobalt is preferable for the positive electrode material. The chemical formula of this compound is expressed by, for example, LiₓM₁O₂ or Li_{y}M₂PO₄, where M₁ and M₂ represent at least one kind of transition metal elements, and x and y represent a value varied depending on a charging or discharging status of a battery, which typically satisfy 0.05≦x≦1.10 and 0.05≦y≦1.10.

Examples of the complex oxide composed of lithium and transition metal elements include a lithium cobalt complex oxide (LiₓCoO₂), a lithium nickel complex oxide (LiₓNiO₂), and a lithium nickel cobalt complex oxide. Examples of the lithium nickel cobalt complex oxide include a lithium nickel cobalt aluminum complex oxide (NCA) or a lithium nickel cobalt manganese complex oxide (NCM).

Examples of the phosphoric acid compound composed of lithium and transition metal elements include a lithium iron phosphoric acid compound (LiFePO₄), a lithium iron manganese phosphoric acid compound (LiFe₁₋ᵤMnᵤPO₄(0<u<1)). Use of these positive electrode materials enables a higher battery capacity and excellent cycle performance.

### [Negative Electrode]

The negative electrode is configured as in the above negative electrode 10 for a lithium-ion secondary battery shown in FIG. 1, and, for example, has the negative electrode active material layer disposed on both faces of the current collector. The negative electrode preferably has a negative-electrode charge capacity larger than a battery charge capacity (electrical capacitance) provided by the positive electrode active material. This negative electrode itself can inhibit the precipitation of lithium metal.

The positive electrode active material layer is formed partially on both faces of the positive electrode current collector. The same is true of the negative electrode active material layer. Such a negative electrode may have, for example, an area at which the positive electrode active material layer is not present on the surface of the positive electrode current collector that the negative electrode active material layer faces. This area permits stable battery design.

The above area at which the positive and negative electrode active material layers do not face one another is hardly affected by charging and discharging. The status of the negative electrode active material layer is consequently maintained since its formation. This enables repeatable investigation of the composition of negative electrode active material with high precision without being affected by charging and discharging.

### [Separator]

The separator separates the positive electrode and the negative electrode, prevents short circuit current due to contact of these electrodes, and passes lithium ions therethrough. This separator may be made of, for example, a porous film of synthetic resin or ceramics, or two or more stacked porous films. Examples of the synthetic resin include polytetrafluoroethylene, polypropylene, and polyethylene.

### [Electrolyte]

At least a part of the active material layers or the separator is impregnated with a liquid electrolyte (an electrolyte solution). The electrolyte is composed of electrolyte salt dissolved in a solvent and may contain other materials such as additives.

The solvent may be, for example, a non-aqueous solvent. Examples of the non-aqueous solvent include ethylene carbonate, propylene carbonate, butylene carbonate, dimethyl carbonate, diethyl carbonate, ethylmethyl carbonate, carbonic acid propylmethyl ester, 1,2-dimethoxyethane, and tetrahydrofuran. Among these, ethylene carbonate, propylene carbonate, dimethyl carbonate, diethyl carbonate, or ethylmethyl carbonate, or the combination thereof is preferable. Such solvent enables better performances. The combination of a viscous solvent, such as ethylene carbonate or propylene carbonate, and a non-viscous solvent, such as dimethyl carbonate, diethyl carbonate or ethylmethyl carbonate allows much better performances, for such a solvent improves the dissociation of electrolyte salt and ionic mobility.

For an alloyed electrode, the solvent preferably contains at least one of a halogenated chain carbonic acid ester and a halogenated cyclic carbonic acid ester. Such a solvent enables the negative electrode active material to be coated with a stable coating at discharging and particularly charging. The halogenated chain carbonic acid ester is a chain carbonic acid ester containing halogen, in which at least one hydrogen atom is substituted with halogen. The halogenated cyclic carbonic acid ester is a cyclic carbonic acid ester containing halogen, in which at least one hydrogen atom is substituted with halogen.

The halogen is preferably, but not particularly limited to, fluorine, for fluorine enables the formation of better coating than other halogens do. A larger number of halogens is better, for a more stable coating can be obtained, thus reducing the decomposition reaction of an electrolyte.

Examples of the halogenated chain carbonic acid ester include carbonic acid fluoromethylmethyl ester and carbonic acid methyl(difluoromethyl) ester. Examples of the halogenated cyclic carbonic acid ester include 4-fluoro-1,3-dioxolan-2-one and 4,5-difluoro-1,3-dioxolan-2-one.

The solvent preferably contains an unsaturated carbon bond cyclic carbonate as an additive, for this enables the formation of a stable coating on a negative electrode at charging and discharging and the inhibition of the decomposition reaction of an electrolyte. Examples of the unsaturated carbon bond cyclic carbonate include vinylene carbonate and vinyl ethylene carbonate.

In addition, the solvent preferably contains sultone (cyclic sulfonic acid ester) as an additive, for this enables improvement in chemical stability of a battery. Examples of the sultone include propane sultone and propene sultone.

In addition, the solvent preferably contains acid anhydride, for this enables improvement in chemical stability of the electrolyte. The acid anhydride may be, for example, propane disulfonic acid anhydride.

The electrolyte salt may contain, for example, at least one light metal salt such as lithium salt. Examples of the lithium salt include lithium hexafluorophosphate (LiPF₆), and lithium tetrafluoroborate (LiBF₄).

The content of the electrolyte salt in the solvent is preferably in the range from 0.5 mol/kg to 2.5 mol/kg. This content enables high ionic conductivity.

### [Manufacture of Laminate Film Secondary Battery]

Firstly, a positive electrode is produced with the above positive electrode material as follows. A positive electrode mixture is created by mixing the positive electrode material with as necessary the binder, the conductive additive, and other materials, and dispersed in an organic solvent to form slurry of the positive-electrode mixture. This slurry is then applied to a positive electrode current collector with a coating apparatus such as a die coater having a knife roll or a die head, and dried by hot air to obtain a positive electrode active material layer. The positive electrode active material layer is finally compressed with, for example, a roll press. The compression may be performed under heating. The compression may be repeated multiple times.

Secondly, a negative electrode active material layer is formed on a negative electrode current collector to produce a negative electrode through the same procedure as in the above production of the negative electrode 10 for a lithium-ion secondary battery.

When the positive electrode and the negative electrode are produced, the active material layers are formed on both faces of the positive and negative electrode current collectors. In both the electrodes, the length of these active material layers formed on the faces may differ from one another (See FIG. 1).

Finally, the following steps are carried out in the order described. An electrolyte is prepared. With ultrasonic welding, the positive electrode lead 32 is attached to the positive electrode current collector and the negative-electrode lead 33 is attached to the negative electrode current collector. The positive and negative electrodes and the separator interposed therebetween are stacked or wound to produce the wound electrode body 31 and a protecting tape is stuck to the outermost circumference of the body. The electrode body is flattened. The film-shaped outer part 35 is folded in half to interpose the electrode body therebetween. The outer edge of the half parts is stuck to one another by heat sealing such that one of the four sides is opened to house the electrode body. The close adhesion films are inserted between the outer part and the positive and negative electrode leads. The prepared electrolyte is introduced from the open side in a prescribed amount to perform the impregnation of the electrolyte under a vacuum. The open side is stuck by vacuum heat sealing.

In this manner, the laminate film secondary battery 30 can be produced.

In the inventive non-aqueous electrolyte secondary battery such as the laminate film secondary battery 30 produced above, the utilization factor of the negative electrode is preferably 93% or more and 99% or less.

The battery having a negative electrode utilization factor of 93% or more prevents reduction in the first charge efficiency and greatly improves the battery capacity; one having a negative electrode utilization factor of 99% or less prevents the precipitation of lithium, thereby ensuring safety.

### EXAMPLE

The present invention will be more specifically described below with reference to examples and comparative examples, but the present invention is not restricted to these examples.

### Example 1-1

A laminate film secondary battery 30 shown in FIG. 3 was produced in the following manner.

The procedure began with the production of a positive electrode. Positive electrode active materials of 95 mass parts of lithium cobaltate (LiCoO₂), 2.5 mass parts of positive-electrode conductive additive, and 2.5 mass parts of positive-electrode binders (polyvinylidene fluoride, PVDF) were mixed to produce a positive-electrode mixture. The positive-electrode mixture was dispersed in an organic solvent (N-methyl-2-pyrrolidone, NMP) to form paste slurry. The slurry was applied to both faces of a positive-electrode current collector with a coating apparatus having a die head and dried with a drying apparatus of hot-air type. The positive-electrode current collector had a thickness of 15 μm. The resultant was finally compressed with a roll press.

Next, a negative electrode was produced. For the production of a negative electrode active material, a mixed raw material of metallic silicon and silicon dioxide was placed in a reactor and evaporated under a vacuum of 10 Pa to deposit the evaporated material on an adsorption plate. The deposit was sufficiently cooled and then taken out to pulverize the deposit with a ball mill. After adjusting the particle size of the obtained powder, the powder was coated with a carbon layer by thermal CVD, as needed. The produced powder was bulk-modified by an electrochemical method in a mixed solvent having a propylene-carbonate-to-ethylene-carbonate volume ratio of 1:1, including 1.3 mol/kg of electrolyte salt. Then, the silicon-based active material particles and natural graphite were blended at a weight ratio of 15:85 (synthetic graphite, hard carbon, and soft carbon were mixed to some negative electrodes, as needed). The blended negative electrode active materials, a first conductive additive (carbon nanotube, CNT), a second conductive additive, a styrene butadiene copolymer (hereinafter, referred to as SBR), and carboxymethyl cellulose (hereinafter, referred to as CMC) were mixed at a dry-weight ratio of 90.5-92.5:1:1:2.5:3-5. The mixture was diluted with pure water to form slurry of a negative-electrode mixture. The negative electrode current collector used was an electrolytic copper foil, having a thickness of 15 μm. The resultant current collector was finally dried under a vacuum at 100° C. for 1 hour.

Besides, the silicon-based active material particles and natural graphite were blended at a weight ratio of 50:50. This active material, a first conductive additive, a second conductive additive, and a precursor of negative-electrode binder were mixed at a dry-weight ratio of 80-83:10:2:5-8. The mixture was diluted with NMP to form paste slurry of a negative-electrode mixture. The NMP was used as a solvent for polyamic acid. The negative-electrode mixture slurry was then applied to both faces of a negative electrode current collector with a coating apparatus and dried. The negative electrode current collector used was an electrolytic copper foil, having a thickness of 15 m. The resultant current collector was finally fired at 400° C. for 1 hour under a vacuum. In this manner, a negative electrode binder (polyimide) was formed.

Then, a solvent was produced by mixing 4-fluoro-1,3-dioxolan-2-one (FEC), ethylene carbonate (EC), and dimethyl carbonate (DMC). An electrolyte salt (lithium hexafluorophosphate, LiPF₆) was dissolved therein to produce an electrolyte. The composite of the solvent was FEC:EC:DMC=10:20:70 in term of the volume. The content of the electrolyte salt in the solvent was 1.2 mol/kg.

The secondary battery was assembled by the following procedure. An aluminum lead was first ultrasonic-welded to one end of the positive-electrode current collector. A nickel lead was welded to one end of the negative-electrode current collector. The positive electrode, a separator, the negative electrode, a separator were then stacked in this order and wound in a longitudinal direction to obtain a wound electrode body. The end of the wounded part was fixed by a PET protecting tape. The separators were a 12-μp laminate film composed of a porous polyethylene film interposed between porous polypropylene films. The electrode body was interposed between outer parts and the outer circumferences, except one side were heat-sealed to house the electrode body therein. The outer parts were an aluminum laminate film composed of a nylon film, aluminum foil, and a polypropylene film stacked. The prepared electrolyte was poured from an open side to perform the impregnation of the electrolyte under a vacuum. The open side was stuck by heat sealing.

### Examples 1-2 to 1-6

A secondary battery was produced as in example 1-1 except that the content of the silicon-based active material with respect to the total amount of the negative electrode active materials (also referred to as SiO material content below) was changed within the range of 6 mass % or more, as shown in Table 1. In the case that SiO material content exceeds 15% like examples 1-3 to 1-6, SBR/CMC is insufficient for the binder, so that PI (polyimide) was used as the binder.

### Comparative Example 1-1 to 1-3

A secondary battery was produced as in example 1-1 except that the content of the silicon-based active material with respect to the total amount of the negative electrode active materials was changed within the range of less than 6 mass %, as shown in Table 1. In comparative example 1-1, the SiO material content was 0 mass %, and the negative electrode active material was only a carbon-based active material.

All silicon-based active materials in examples 1-1 to 1-6 and comparative examples 1-2 and 1-3 had the following physical properties: the silicon-based active material had a median size Y of 4 μm; the half width (2θ) of the diffraction peak attributable to an (111) crystal face and obtainable by X-ray diffraction was 2.593°; the crystallite size attributable to the (111) crystal face was 3.29 nm; the silicon-based active material was SiOₓ where x=1.0; the silicon-based active material contained LiF, Li₂CO₃, and carbon layer (C layer) on its surface; the silicon-based active material contained Li₂SiO₃ and Li₄SiO₄ in its interior.

In addition, the silicon-based active material had a peak intensity ratio of A/B=2 where A is a peak intensity of an Si region represented by a chemical shift value of −60 ppm to −100 ppm and B is a peak intensity of an SiO₂ region represented by a chemical shift value of −100 ppm to −150 ppm, as obtained from a ²⁹Si-MAS-NMR spectrum.

All carbon-based active materials in examples 1-1 to 1-6 and comparative examples 1-1 to 1-3 had the following physical properties: the carbon-based active material had a median size X of 20 μm, and thus the ratio of the median size X of the carbon-based active material to the median size Y of the silicon-based active material was X/Y=5; the natural graphite content in the carbon-based active material was 100%.

The cycle performance and the first charge and discharge performance of the secondary batteries in examples 1-1 to 1-6 and comparative examples 1-1 to 1-3 were investigated. The result is given in Table 1.

The cycle performance was investigated in the following manner: First, two cycles of charging and discharging were performed at 25° C. to stabilize the battery, and the discharge capacity in the second cycle was measured. At this time, the silicon-based active material (SiO material) had an initial efficiency of 80%. Next, the cycle of charging and discharging was repeated until the total number of cycles reached 100 cycles and the discharge capacity was measured every cycle. Finally, a capacity retention rate was calculated by dividing the discharge capacity in the 100-th cycle by the discharge capacity in the second cycle and multiplying the resultant by 100 to express as a percent. The cycle conditions were as follows: The secondary batteries were charged at a constant current density of 2.5 mA/cm² until the voltage reached 4.3 V. After this voltage reached 4.3 V, the charging was continued while the current density became 0.25 mA/cm² at 4.3 V. The batteries were then discharged at a constant current density of 2.5 mA/cm² until the voltage of the battery reached 3.0 V.

In this operation, the batteries were charged with a lithium counter electrode in constant current (CC) mode until 0 V, followed by constant voltage (CV) mode from 0 V. When the current became 0.07 C, the charging was terminated. After charging, the batteries were discharged in constant current (CC) mode until the battery voltage reached 3.0 V.

The first charge and discharge efficiency was calculated by the following expression:

Initial Efficiency (%)=(First Discharge Capacity/First Charge Capacity)×100

The atmosphere temperature was the same as the cycle performance was investigated. The charging and discharging conditions were 0.2 times the conditions of the investigation of the cycle performance. More specifically, the secondary batteries were charged at a constant current density of 0.5 mA/cm² until the voltage reached 4.3 V. After this voltage reached 4.3 V, the charging was continued while the current density became 0.05 mA/cm² at 4.3 V. The batteries were then discharged at a constant current density of 0.5 mA/cm² until the voltage of the battery reached 3.0 V.

TABLE 1

| | | | Negative | | | | | | | |
|---|---|---|---|---|---|---|---|---|---|---|
| | | Negative | electrode | | | | | | | |
| | SiO | electrode | volume | | | | | | | |
| | material | cutoff | density at | | Li | | | | Capacity | Initial |
| | content | voltage | charging | | compound | Li₂SiO₃ | Li₄SiO₄ | Surface | retention | efficiency |
| | (%) | (V) | (g/cc) | Binder | in bulk | crystallinity | crystallinity | layer | rate (%) | (%) |
| Comparative | 0 | 0.469 | 1.45 | SBR/CMC | — | — | — | — | 95.0 | 90.0 |
| example | | | | | | | | | | |
| 1-1 | | | | | | | | | | |
| Comparative | 4 | 0.648 | 1.39 | SBR/CMC | Li₂SiO₃, | amorphous | amorphous | LiF, | 91.5 | 88.2 |
| example | | | | | Li₄SiO₄ | | | Li₂CO₃, | | |
| 1-2 | | | | | | | | C layer | | |
| Comparative | 5 | 0.675 | 1.33 | SBR/CMC | Li₂SiO₃, | amorphous | amorphous | LiF, | 91.0 | 87.8 |
| example | | | | | Li₄SiO₄ | | | Li₂CO₃, | | |
| 1-3 | | | | | | | | C layer | | |
| Example | 6 | 0.695 | 1.31 | SBR/CMC | Li₂SiO₃, | amorphous | amorphous | LiF, | 90.0 | 87.5 |
| 1-1 | | | | | Li₄SiO₄ | | | Li₂CO₃, | | |
| | | | | | | | | C layer | | |
| Example | 10 | 0.732 | 1.15 | SBR/CMC | Li₂SiO₃, | amorphous | amorphous | LiF, | 88.0 | 86.3 |
| 1-2 | | | | | Li₄SiO₄ | | | Li₂CO₃, | | |
| | | | | | | | | C layer | | |
| Example | 15 | 0.760 | 1 | PI | Li₂SiO₃, | amorphous | amorphous | LiF, | 87.5 | 85.2 |
| 1-3 | | | | | Li₄SiO₄ | | | Li₂CO₃, | | |
| | | | | | | | | C layer | | |
| Example | 30 | 0.799 | 0.94 | PI | Li₂SiO₃, | amorphous | amorphous | LiF, | 87 | 83.1 |
| 1-4 | | | | | Li₄SiO₄ | | | Li₂CO₃, | | |
| | | | | | | | | C layer | | |
| Example | 50 | 0.825 | 0.87 | PI | Li₂SiO₃, | amorphous | amorphous | LiF, | 86.4 | 81.6 |
| 1-5 | | | | | Li₄SiO₄ | | | Li₂CO₃, | | |
| | | | | | | | | C layer | | |
| Example | 80 | 0.834 | 0.8 | PI | Li₂SiO₃, | amorphous | amorphous | LiF, | 86 | 80.0 |
| 1-6 | | | | | Li₄SiO₄ | | | Li₂CO₃, | | |
| | | | | | | | | C layer | | |

The batteries having high SiO content decreased the volume density at charging and increased the cutoff voltage of the negative electrode.

In addition, the capacity increase rate of the secondary batteries in comparative example 1-1 and examples 1-2, 1-4 to 1-6 was investigated. The result is given in Table 1a. Herein, the capacity increase rate was calculated on the basis of a battery capacity when the content of the silicon-based active material was 0 wt %.

TABLE 1a

| | | Increase ratio of |
|---|---|---|
| | SiO material | battery capacity |
| | content (%) | (Wh %) |
| Comparative | 0 | 0 |
| example 1-1 | | |
| Example 1-2 | 10 | 4.5 |
| Example 1-4 | 30 | 12.6 |
| Example 1-5 | 50 | 16.4 |
| Example 1-6 | 80 | 17.9 |

Table 1a shows that as the content of the silicon-based active material increased, the effect of the carbon material on the SiO discharge potential decreased, and thus the battery capacity increased.

The graph of FIG. 4 shows the relationship between the content of the silicon-based active material with respect to the total amount of the negative electrode active materials and the increase rate of the battery capacity of the secondary battery.

Curve a in FIG. 4 shows an increase rate of the battery capacity when the content of the silicon-based active material was increased in the negative electrode active materials of the present invention. Curve b in FIG. 4 shows an increase rate of the battery capacity when the content of a silicon-based active material that was not doped with lithium was increased.

As shown in FIG. 4, the increase rate of the battery capacity of curve a was larger than that of curve b, especially within the range where the content of the silicon-based active material is 6 wt % or more. The difference therebetween increased with the increase of the content of the silicon-based active material. These results of Table 1, Table 1a, and FIG. 4 indicate that the present invention, in which the negative electrode active materials include the silicon-based active material in an amount of 6 wt % or more, had a larger increase rate of the battery capacity than conventional one, and thus the volume energy density of the negative electrode active materials significantly increased especially within the above content range.

Meanwhile, comparative examples 1-1 to 1-3, in which the SiO content is 5 mass % or less, exhibited high retention rate and high initial efficiency due to high content of the carbon-based active material. However, volume energy density (Wh/l) of these batteries did not increase because the carbon-based active material highly affected the SiQ discharge potential.

### Examples 2-1 to 2-5 and Comparative Examples 2-1 and 2-2

A secondary battery was produced as in example 1-2 except that oxygen amount in a bulk of the silicon-based active material was adjusted when the negative electrode material was produced. The amount of accumulated oxygen was adjusted by changing the temperature and the ratio of raw materials to be vaporized. Table 2 shows the x-value of the silicon-based active material expressed by SiOₓ in examples 2-1 to 2-5 and comparative examples 2-1 and 2-2.

The cycle performance and the first charge and discharge performance of the secondary batteries in examples 2-1 to 2-5 and comparative examples 2-1 and 2-2 were investigated. The result is given in Table 2.

TABLE 2

| | | Negative | | | |
|---|---|---|---|---|---|
| | | electrode | SiO initial | Capacity | Initial |
| | SiOx | cutoff | efficiency | retention | efficiency |
| | (X=) | voltage (V) | (%) | rate (%) | (%) |
| Comparative | 0.3 | 0.69 | 82 | 45 | 87.1 |
| example 2-1 | | | | | |
| Example 2-1 | 0.5 | 0.70 | 81 | 80 | 86.7 |
| Example 2-2 | 0.7 | 0.71 | 80 | 83 | 86.4 |
| Example 2-3 | 0.9 | 0.73 | 80 | 86 | 86.3 |
| Example 2-4 | 1.2 | 0.73 | 80 | 88 | 86.3 |
| Example 2-5 | 1.6 | 0.75 | 80 | 87 | 86.3 |
| Comparative | 1.8 | — | — | — | — |
| example 2-2 | | | | | |

As shown in Table 2, when the oxygen amount was lack (comparative example 2-1, x=0.3), the capacity retention rate significantly degraded although the initial efficiency was improved. When the oxygen amount was excess (comparative example 2-2, x=1.8), the conductivity decreased, and thus the capacity of the SiO material was not exhibited according to design. In this case, only the carbon material was charged and discharged, but the capacity was not increased so that the evaluation was stopped.

### Examples 3-1 to 3-5

A secondary battery was produced as in example 1-2 except that the utilization factor of the negative electrode of the secondary battery was changed as shown in Table 3. The cutoff voltage of the negative electrode and the volume density of the negative electrode active material at charging were changed accordingly as shown in Table 3.

The cycle performance and the first charge and discharge performance of the secondary batteries in examples 3-1 to 3-5 were investigated. The result is given in Table 3.

TABLE 3

| | Volume | Negative | Negative | | |
|---|---|---|---|---|---|
| | density at | electrode | electrode | Capacity | Initial |
| | charging | cutoff | utilization | retention | efficien- |
| | (g/cc) | voltage (V) | factor (%) | rate (%) | cy (%) |
| Example 3-1 | 1.11 | 0.78 | 90 | 89 | 85.5 |
| Example 3-2 | 1.11 | 0.76 | 92 | 88.7 | 85.8 |
| Example 3-3 | 1.13 | 0.74 | 93 | 88.5 | 86.1 |
| Example 3-4 | 1.16 | 0.72 | 97 | 87.8 | 86.7 |
| Example 3-5 | 1.18 | 0.71 | 99 | 87.6 | 86.9 |

The batteries having a negative electrode utilization factor of 93% or more (examples 3-3 to 3-5) increased the initial efficiency and thus improved the battery capacity more than those of the batteries having a negative electrode utilization factor of less than 93% (examples 3-1 and 3-2).

A battery having a negative electrode utilization factor of 100% can increase the battery capacity, but it is feared that lithium is precipitated depending on design. Thus, the examination was conducted with a maximum utilization factor of 99%. The examination demonstrated that the negative electrode utilization factor was preferably 93% or more and 99% or less when the increase in the battery capacity was considered.

### Examples 4-1 and 4-2 and Comparative Example 4-1

A secondary battery was produced as in example 1-2 except that, in example 4-1, the silicon-based active material was coated with LiF and carbon layer, and in example 4-2, the silicon-based active material was coated with Li₂CO₃ and carbon layer. In comparative example 4-1, none of LiF, Li₂CO₃ and carbon layer were formed on the surface.

The cycle performance and the first charge and discharge performance of the secondary batteries in examples 4-1 and 4-2 and comparative example 4-1 were investigated. The result is given in Table 4.

TABLE 4

| | | Capacity | Initial |
|---|---|---|---|
| | | retention | efficiency |
| | Surface layer | rate (%) | (%) |
| Comparative | — | 84.5 | 82.1 |
| example 4-1 | | | |
| Example 4-1 | LiF, C layer | 85.0 | 85.8 |
| Example 4-2 | Li₂CO₃, C layer | 86.0 | 85.6 |
| Example 1-2 | LiF, Li₂CO₃, C layer | 88.0 | 86.3 |

As shown in Table 4, when the silicon-based active material was coated with LiF, Li₂CO₃, and carbon layer, both the capacity retention rate and the initial efficiency were improved.

### Examples 5-1 to 5-6

A secondary battery was produced as in example 1-2 except that Si/SiO₂ components produced in the bulk were changed to increase or decrease the initial efficiency of SiO alone and change the ratio A/B, where A is a peak intensity of an Si region represented by a chemical shift value of −60 ppm to −100 ppm and B is a peak intensity of an SiO₂ region represented by a chemical shift value of −100 ppm to −150 ppm that are obtained from a ²⁹Si-MAS-NMR spectrum, as shown in Table 5. This ratio can be controlled by subjecting the SiO₂ region to a potential-controlled electrochemical Li-doping method.

The cycle performance and the first charge and discharge performance of the secondary batteries in examples 5-1 to 5-6 were investigated. The result is given in Table 5.

TABLE 5

| | SiO | | Negative | | |
|---|---|---|---|---|---|
| | initial | | electrode | Capacity | Initial |
| | efficiency | A(Si)/ | cutoff | retention | efficiency |
| | (%) | B(SiO₂) | voltage (V) | rate (%) | (%) |
| Example 1-2 | 80 | 2 | 0.73 | 88.0 | 86.3 |
| Example 5-1 | 65 | 0.3 | 0.86 | 83.0 | 79.6 |
| Example 5-2 | 70 | 0.4 | 0.84 | 84.0 | 82.0 |
| Example 5-3 | 73 | 0.8 | 0.80 | 85.0 | 83.4 |
| Example 5-4 | 75 | 1 | 0.78 | 86.5 | 84.3 |
| Example 5-5 | 90 | 2.5 | 0.47 | 88.5 | 86.7 |
| Example 5-6 | 95 | 3 | 0.35 | 89.0 | 87.1 |

As shown in Table 5, when the peak intensity B of the SiO₂ region of the chemical shift value obtained from the ²⁹Si-MAS-NMR spectrum was small, namely when A/B was 0.8 or more, high battery performances were achieved. This indicates that the initial efficiency of the battery can be improved by previously reducing the SiO₂ portion, which is a Li-reacting site, as well as the battery degradation with charging and discharging can be inhibited by the stable lithium compound in the bulk or on the surface.

Moreover, examples 5-2 to 5-6, in which the negative electrode has a cutoff voltage of 0.35 V to 0.85 V when the battery cutoff voltage is 3.0 V, had better battery performances than example 5-1.

### Examples 6-1 to 6-7

A secondary battery was produced as in example 1-2 except that the type of the carbon-based active material in the negative electrode active materials and the content (mass %) of natural graphite with respect to the total weight of the carbon-based active material were changed as shown in Table 6.

The cycle performance and the first charge and discharge performance of the secondary batteries in examples 6-1 to 6-7 were investigated. The result is given in Table 6.

TABLE 6

| | | Natural | Volume | | Initial |
|---|---|---|---|---|---|
| | Carbon-based | graphite | density at | Capacity | effi- |
| | active | content | charging | retention | ciency |
| | material | (mass %) | (g/cc) | rate (%) | (%) |
| Exam- | natural graphite | 100 | 1.15 | 88.0 | 86.3 |
| ple 1-2 | | | | | |
| Exam- | natural graphite: | 80 | 1.15 | 89.0 | 86.7 |
| ple 6-1 | synthetic graphite | | | | |
| Exam- | natural graphite: | 50 | 1.15 | 90.0 | 87.3 |
| ple 6-2 | synthetic graphite | | | | |
| Exam- | natural graphite: | 30 | 1.22 | 89.0 | 87.6 |
| ple 6-3 | synthetic graphite | | | | |
| Exam- | natural graphite: | 10 | 1.35 | 86.0 | 85.3 |
| ple 6-4 | synthetic graphite | | | | |
| Exam- | natural graphite: | 50 | 1.15 | 89.0 | 83.1 |
| ple 6-5 | hard carbon | | | | |
| Exam- | natural graphite: | 50 | 1.15 | 86.0 | 84.9 |
| ple 6-6 | soft carbon | | | | |
| Exam- | natural graphite: | 50 | 1.15 | 87.0 | 84.5 |
| ple 6-7 | hard carbon: | | | | |
| | synthetic graphite | | | | |

As shown in Table 6, the batteries having a natural graphite content of 30% or more exhibited higher initial efficiency and retention rate than the battery having a natural graphite content of less than 30% (example 6-4). Moreover, the battery performances were improved with the increase of the amount of synthetic graphite to be mixed. Synthetic graphite enables high initial efficiency and cycle performance. Thus, the battery performances are improved by mixing synthetic graphite.

### Example 7-1

A secondary battery was produced as in example 1-2 except that CNT was not added to the negative electrode as a conductive additive.

The cycle performance and the first charge and discharge performance of the secondary battery in example 7-1 was investigated. The result is given in Table 7.

TABLE 7

| | | Capacity | Initial |
|---|---|---|---|
| | | retention | efficiency |
| | CNT | rate (%) | (%) |
| Example 1-2 | 1 mass % | 88.0 | 86.3 |
| Example 7-1 | None | 84.5 | 86.3 |

As shown in Table 7, when CNT was added, both the retention rate and the initial efficiency were improved. This indicates that addition of CNT to the negative electrode allowed an electric contact between the silicon-based active material (SiO material) and the carbon-based active material, thus improving the battery performances.

### Examples 8-1 to 8-6

A secondary battery was produced as in example 1-2 except that the crystallinities of the lithium silicate compound (Li₂SiO₃ and Li₄SiO₄) produced in the bulk of the silicon-based active material were changed. The crystallinity can be changed by a heat treatment under a non-atmospheric condition after insertion and extraction of lithium.

The cycle performance and the first charge and discharge performance of the secondary batteries in examples 8-1 to 8-6 were investigated. The result is given in Table 8.

TABLE 8

| | | | Capacity | Initial |
|---|---|---|---|---|
| | Li₂SiO₃ | Li₄SiO₄ | retention | efficiency |
| | crystallinity | crystallinity | rate (%) | (%) |
| Example 8-1 | amorphous | 0.15° | 82.0 | 86.3 |
| Example 8-2 | amorphous | 0.2° | 85.0 | 86.3 |
| Example 8-3 | amorphous | 1° | 87.0 | 86.3 |
| Example 8-4 | 0.4° | amorphous | 81.0 | 86.3 |
| Example 8-5 | 0.75° | amorphous | 85.0 | 86.3 |
| Example 8-6 | 1° | amorphous | 87.0 | 86.3 |
| Example 1-2 | amorphous | amorphous | 88.0 | 86.3 |

As the crystallinities of the lithium silicate compounds decreased, the capacity retention rate was improved. The reason is supposed to be that the compound with low crystallinity reduced the resistance in the active materials.

### Examples 9-1 to 9-9

A secondary battery was produced as in example 1-2 except that the crystallinity of the silicon-based active material was changed. The crystallinity can be changed by a heat treatment under a non-atmospheric condition after insertion and extraction of lithium. Table 9 shows the half width of the silicon-based active materials in examples 9-1 to 9-9. Although example 9-9 exhibited a half width of 20° or more, this value was obtained by fitting with analysis software because the peak value was not obtained. The silicon-based active material in example 9-9 was substantially amorphous.

The cycle performance and the first charge and discharge performance of the secondary batteries in examples 9-1 to 9-9 were investigated. The result is given in Table 9.

TABLE 9

| | | | Capacity | Initial |
|---|---|---|---|---|
| | Half width 2θ | Crystallite | retention | efficiency |
| | (°) | size (nm) | rate (%) | (%) |
| Example 9-1 | 0.756 | 11.42 | 80.0 | 86.3 |
| Example 9-2 | 0.796 | 10.84 | 81.0 | 86.3 |
| Example 9-3 | 1.025 | 8.55 | 82.0 | 86.3 |
| Example 9-4 | 1.218 | 7.21 | 85.0 | 86.3 |
| Example 9-5 | 1.271 | 6.63 | 86.0 | 86.4 |
| Example 9-6 | 1.845 | 4.62 | 87.0 | 86.3 |
| Example 9-7 | 2.257 | 3.77 | 87.5 | 86.3 |
| Example 1-2 | 2.593 | 3.29 | 88.0 | 86.3 |
| Example 9-8 | 10.123 | 1.524 | 89.0 | 86.3 |
| Example 9-9 | 20.221 | 0 | 90.0 | 86.3 |

As shown in Table 9, the capacity retention rate and the initial efficiency changed in response to the variation in the crystallinity.

In particular, high capacity retention rate and high initial efficiency were obtained by low crystallinity materials with a half width (2θ) of 1.2° or more and a crystallite size of 7.5 nm or less, which is attributable to an Si(111) crystal face. The best battery performances were obtained when the material was amorphous (example 9-9).

### Examples 10-1 to 10-7

A secondary battery was produced as in example 1-2 except that the median size X of the carbon-based active material, the median size Y of the silicon-based active material, and X/Y were changed as shown in Table 10.

The cycle performance and the first charge and discharge performance of the secondary batteries in examples 10-1 to 10-7 were investigated. The result is given in Table 10.

TABLE 10

| | | | | Volume | | |
|---|---|---|---|---|---|---|
| | | | | density at | Capacity | Initial |
| | Median size | Median size | | charging | retention | efficiency |
| | Y (μm) | X (μm) | X/Y | (g/cc) | rate (%) | (%) |
| Example 1-2 | 4 | 20 | 5 | 1.15 | 88.0 | 86.3 |
| Example 10-1 | 4 | 16 | 4 | 1.17 | 88.1 | 86.1 |
| Example 10-2 | 4 | 12 | 3 | 1.19 | 88.0 | 85.8 |
| Example 10-3 | 4 | 8 | 2 | 1.23 | 87.6 | 84.2 |
| Example 10-4 | 4 | 4 | 1 | 1.25 | 87.0 | 83.6 |
| Example 10-5 | 4 | 2 | 0.5 | 1.3 | 83.2 | 82.9 |
| Example 10-6 | 8 | 4 | 0.5 | 1.23 | 81.5 | 81.8 |
| Example 10-7 | 8 | 16 | 2 | 1.26 | 85.6 | 86.5 |

As shown in Table 10, the carbon-based active material in the negative electrode active material layer is preferably equal to or larger than the silicon-based active material. When the silicon-based active material, which was expandable and contractible, was equal to or smaller than the carbon-based active material, breakage of the mixture layer could be prevented. When the carbon-based active material was larger than the silicon-based active material, the volume density of the negative electrode at charging, the initial efficiency, and thus the battery energy density were improved.

### Examples 11-1 to 11-6 and Comparative Examples 11-1 to 11-3

A secondary battery was produced as in example 1-1 except that LiNi_{0.7}Co_{0.25}Al_{0.05}O, a lithium nickel cobalt aluminum complex oxide (NCA), was used as the positive electrode active material and the content of the silicon-based active material (also referred to as SiO material content below) with respect to the total amount of the negative electrode active materials was changed as shown in Table 11-1. However, in the case that the SiO material content exceeds 15% (examples 11-3 to 11-6), SBR/CMC is insufficient for the binder, so that PI binder was used instead. In comparative example 11-1, the SiO material content was 0 mass %, and the negative electrode active material was only a carbon-based active material.

The cycle performance and the first charge and discharge performance of the secondary batteries in examples 11-1 to 11-6 and comparative examples 11-1 to 11-3 were investigated. The result is given in Table 11-1.

The cycle performance was investigated in the following manner: First, two cycles of charging and discharging were performed at 25° C. to stabilize the battery, and the discharge capacity in the second cycle was measured. Next, the cycle of charging and discharging was repeated until the total number of cycles reached 100 cycles and the discharge capacity was measured every cycle. Finally, a capacity retention rate was calculated by dividing the discharge capacity in the 100-th cycle by the discharge capacity in the second cycle and multiplying the resultant by 100 to express as a percent. The cycle conditions were as follows: The secondary batteries were charged at a constant current density of 2.5 mA/cm² until the voltage reached 4.3 V. After this voltage reached 4.3 V, the charging was continued while the current density became 0.25 mA/cm² at 4.3 V. The batteries were then discharged at a constant current density of 2.5 mA/cm² until the voltage of the battery reached 2.5 V.

The first charge and discharge efficiency was calculated by the following expression:

Initial Efficiency (%)=(First Discharge Capacity/First Charge Capacity)×100

The atmosphere temperature was the same as the cycle performance was investigated. The charging and discharging conditions were 0.2 times the conditions of the investigation of the cycle performance. More specifically, the secondary batteries were charged at a constant current density of 0.5 mA/cm² until the voltage reached 4.3 V. After this voltage reached 4.3 V, the charging was continued while the current density became 0.05 mA/cm² at 4.3 V. The batteries were then discharged at a constant current density of 0.5 mA/cm² until the voltage of the battery reached 2.5 V.

In this manner, the cycle performance and the first charge and discharge performance of the secondary battery with a discharge cutoff voltage of 2.5 V were investigated. In the following examples and comparative examples, the cycle performance and the first charge and discharge performance were investigated on secondary batteries with a discharge cutoff voltage of 2.5 V.

TABLE 11-1

| | | | Negative | | | | | | | |
|---|---|---|---|---|---|---|---|---|---|---|
| | | Negative | electrode | | | | | | | |
| | SiO | electrode | volume | | | | | SiO | | |
| | material | cutoff | density at | | Li | | | material | Capacity | Initial |
| | content | voltage | charging | | compound | Li₂SiO₃ | Li₄SiO₄ | surface | retention | efficiency |
| | (%) | (V) | (g/cc) | Binder | in bulk | crystallinity | crystallinity | layer | rate (%) | (%) |
| Comparative | 0 | 0.693 | 1.45 | SBR/CMC | — | — | — | — | 94.0 | 89.8 |
| example | | | | | | | | | | |
| 11-1 | | | | | | | | | | |
| Comparative | 4 | 0.885 | 1.39 | SBR/CMC | Li₂SiO₃, | amorphous | amorphous | LiF, | 90.5 | 88.0 |
| example | | | | | Li₄SiO₄ | | | Li₂CO₃, | | |
| 11-2 | | | | | | | | C layer | | |
| Comparative | 5 | 0.909 | 1.33 | SBR/CMC | Li₂SiO₃, | amorphous | amorphous | LiF, | 90.0 | 87.6 |
| example | | | | | Li₄SiO₄ | | | Li₂CO₃, | | |
| 11-3 | | | | | | | | C layer | | |
| Example | 6 | 0.919 | 1.31 | SBR/CMC | Li₂SiO₃, | amorphous | amorphous | LiF, | 89.0 | 87.2 |
| 11-1 | | | | | Li₄SiO₄ | | | Li₂CO₃, | | |
| | | | | | | | | C layer | | |
| Example | 10 | 0.947 | 1.15 | SBR/CMC | Li₂SiO₃, | amorphous | amorphous | LiF, | 87.0 | 86.1 |
| 11-2 | | | | | Li₄SiO₄ | | | Li₂CO₃, | | |
| | | | | | | | | C layer | | |
| Example | 15 | 0.971 | 1 | PI | Li₂SiO₃, | amorphous | amorphous | LiF, | 86.6 | 85.0 |
| 11-3 | | | | | Li₄SiO₄ | | | Li₂CO₃, | | |
| | | | | | | | | C layer | | |
| Example | 30 | 0.996 | 0.94 | PI | Li₂SiO₃, | amorphous | amorphous | LiF, | 85.8 | 82.8 |
| 11-4 | | | | | Li₄SiO₄ | | | Li₂CO₃, | | |
| | | | | | | | | C layer | | |
| Example | 50 | 1.011 | 0.87 | PI | Li₂SiO₃, | amorphous | amorphous | LiF, | 85.3 | 81.3 |
| 11-5 | | | | | Li₄SiO₄ | | | Li₂CO₃, | | |
| | | | | | | | | C layer | | |
| Example | 80 | 1.025 | 0.8 | PI | Li₂SiO₃, | amorphous | amorphous | LiF, | 84.9 | 79.7 |
| 11-6 | | | | | Li₄SiO₄ | | | Li₂CO₃, | | |
| | | | | | | | | C layer | | |

### Examples 11-7 to 11-12 and Comparative Examples 11-4 to 11-6

A secondary battery was produced as in example 1-1 except that LiCo_{0.33}Ni_{0.33}Mn_{0.33}O₂, a lithium nickel cobalt manganese complex oxide (NCM), was used as the positive electrode active material and the content of the silicon-based active material (also referred to as SiO material content below) with respect to the total amount of the negative electrode active materials was changed as shown in Table 11-2. However, in the case that the SiO material content exceeds 15% (examples 11-9 to 11-12), SBR/CMC is insufficient for the binder, so that PI binder was used instead. In comparative example 11-4, the SiO material content was 0 mass %, and the negative electrode active material was only a carbon-based active material.

The cycle performance and the first charge and discharge performance of the secondary batteries with a discharge cutoff voltage of 2.5 V were investigated in the same manner as in examples 11-1 to 11-6 and comparative examples 11-1 to 11-3. The result is given in Table 11-2.

TABLE 11-2

| | | | Negative | | | | | | | |
|---|---|---|---|---|---|---|---|---|---|---|
| | | Negative | electrode | | | | | | | |
| | SiO | electrode | volume | | | | | SiO | | |
| | material | cutoff | density at | | Li | | | material | Capacity | Initial |
| | content | voltage | charging | | compound | Li₂SiO₃ | Li₄SiO₄ | surface | retention | efficiency |
| | (%) | (V) | (g/cc) | Binder | in bulk | crystallinity | crystallinity | layer | rate (%) | (%) |
| Comparative | 0 | 0.437 | 1.45 | SBR/CMC | — | — | — | — | 94.1 | 88.9 |
| example | | | | | | | | | | |
| 11-4 | | | | | | | | | | |
| Comparative | 4 | 0.790 | 1.39 | SBR/CMC | Li₂SiO₃, | amorphous | amorphous | LiF, | 90.3 | 87.9 |
| example | | | | | Li₄SiO₄ | | | Li₂CO₃, | | |
| 11-5 | | | | | | | | C layer | | |
| Comparative | 5 | 0.860 | 1.33 | SBR/CMC | Li₂SiO₃, | amorphous | amorphous | LiF, | 90.1 | 87.4 |
| example | | | | | Li₄SiO₄ | | | Li₂CO₃, | | |
| 11-6 | | | | | | | | C layer | | |
| Example | 6 | 0.891 | 1.31 | SBR/CMC | Li₂SiO₃, | amorphous | amorphous | LiF, | 88.8 | 87.1 |
| 11-7 | | | | | Li₄SiO₄ | | | Li₂CO₃, | | |
| | | | | | | | | C layer | | |
| Example | 10 | 0.951 | 1.15 | SBR/CMC | Li₂SiO₃, | amorphous | amorphous | LiF, | 86.9 | 85.9 |
| 11-8 | | | | | Li₄SiO₄ | | | Li₂CO₃, | | |
| | | | | | | | | C layer | | |
| Example | 15 | 0.992 | 1 | PI | Li₂SiO₃, | amorphous | amorphous | LiF, | 86.1 | 84.7 |
| 11-9 | | | | | Li₄SiO₄ | | | Li₂CO₃, | | |
| | | | | | | | | C layer | | |
| Example | 30 | 1.034 | 0.94 | PI | Li₂SiO₃, | amorphous | amorphous | LiF, | 85.9 | 82.9 |
| 11-10 | | | | | Li₄SiO₄ | | | Li₂CO₃, | | |
| | | | | | | | | C layer | | |
| Example | 50 | 1.051 | 0.87 | PI | Li₂SiO₃, | amorphous | amorphous | LiF, | 85 | 80.9 |
| 11-11 | | | | | Li₄SiO₄ | | | Li₂CO₃, | | |
| | | | | | | | | C layer | | |
| Example | 80 | 1.063 | 0.8 | PI | Li₂SiO₃, | amorphous | amorphous | LiF, | 84.6 | 79.3 |
| 11-12 | | | | | Li₄SiO₄ | | | Li₂CO₃, | | |
| | | | | | | | | C layer | | |

Table 11-1 and Table 11-2 show that whether the negative electrode active material was NCA or NCM, the batteries having high SiO material content decreased the volume density at charging and increased the cutoff voltage of the negative electrode.

In addition, the capacity increase rate of the secondary batteries in comparative example 11-1 and examples 11-2, 11-4 to 11-6 was investigated. The result is given in Table 11a. Herein, the capacity increase rate was calculated on the basis of a battery capacity when the content of the silicon-based active material was 0 wt %.

TABLE 11a

| | | Increase ratio of |
|---|---|---|
| | SiO material | battery capacity |
| | content (%) | (Wh %) |
| Comparative | 0 | 0 |
| example 11-1 | | |
| Example 11-2 | 10 | 7.912 |
| Example 11-4 | 30 | 18.952 |
| Example 11-5 | 50 | 23.744 |
| Example 11-6 | 80 | 26.248 |

The graph of FIG. 4 also shows the relationship between the content of the silicon-based active material with respect to the total amount of the negative electrode active materials and the increase rate of the battery capacity of the secondary battery when the positive electrode is NCA.

Curve c in FIG. 4 shows an increase rate of the battery capacity when the content of the silicon-based active material was increased in the negative electrode active materials of the present invention. Curve d in FIG. 4 shows an increase rate of the battery capacity when the content of a silicon-based active material that was not doped with lithium was increased. Also in this case, the secondary battery containing the inventive negative electrode, in which the negative electrode active materials include the silicon-based active material in an amount of 6 wt % or more, had a larger increase rate of the battery capacity than conventional one, and thus the volume energy density of the negative electrode active material was significantly increased.

Comparative examples 11-1 to 11-6, in which the SiO material content is 5 mass % or less, exhibited high retention rate and high initial efficiency due to high content of the carbon-based active material. However, volume energy density (Wh/l) of these batteries did not increase because the carbon-based active material highly affected the SiO discharge potential. The volume energy density significantly increased when the negative electrode active materials include the silicon-based active material in an amount of 6 mass % or more.

The reason is as follows. A usual carbon material has an reversible capacity of 330 mAh/g while the SiO material has 1500 mAh/g. When the SiO material was added, for example, in an amount of 5 mass %, the silicon-based active material accounts for about 19% of the negative electrode capacity. When the SiO material was added in an amount of 6 mass %, the silicon-based active material accounts for about 22.5% of the negative electrode capacity. In the region concerning this capacity, the change of the discharge curve shape of the negative electrode potential is important. In particular, when the SiO material was added in an amount of 5 mass % or less, the discharge curve of the negative electrode was highly affected, resulting in substantially less improvement in the battery capacity. By contrast, when the SiO material was added in an amount of 6 mass % or more, the silicon-based active material accounts for a more part of the capacity, substantially enabling improvement in the battery capacity.

In the following, secondary batteries using NCM as the positive electrode active material were produced for examinations.

### Examples 12-1 to 12-5 and Comparative Examples 12-1 and 12-2

A secondary battery was produced as in example 11-8 except that oxygen amount in the bulk of the silicon-based active material was adjusted when the negative electrode material was produced. The amount of accumulated oxygen was adjusted by changing the temperature and the ratio of raw materials to be vaporized. Table 12 shows the x-value of the silicon-based active material expressed by SiOₓ in examples 12-1 to 12-5 and comparative examples 12-1 and 12-2.

The cycle performance and the first charge and discharge performance of the secondary batteries in examples 12-1 to 12-5 and comparative examples 12-1 and 12-2 were investigated. The result is given in Table 2.

TABLE 12

| | | Negative | | | |
|---|---|---|---|---|---|
| | | electrode | SiO initial | Capacity | Initial |
| | SiOx | cutoff | efficiency | retention | efficiency |
| | (X =) | voltage (V) | (%) | rate (%) | (%) |
| Comparative | 0.3 | 0.95 | 82 | 42 | 86.7 |
| example 12-1 | | | | | |
| Example 12-1 | 0.5 | 0.95 | 81 | 78 | 86.3 |
| Example 12-2 | 0.7 | 0.95 | 80 | 82.1 | 86.0 |
| Example 12-3 | 0.9 | 0.95 | 80 | 86.5 | 85.9 |
| Example 12-4 | 1.2 | 0.95 | 80 | 87.5 | 86.9 |
| Example 12-5 | 1.6 | 0.95 | 80 | 86.8 | 85.9 |
| Comparative | 1.8 | — | — | — | — |
| example 12-2 | | | | | |

As shown in Table 12, when the oxygen amount was lack (comparative example 12-1, x=0.3), the capacity retention rate significantly degraded although the initial efficiency was improved. When the oxygen amount was excess (comparative example 12-2, x=1.8), the conductivity decreased, and thus the capacity of the SiO material was not exhibited according to design. In this case, only the carbon material was charged and discharged, but the capacity was not increased so that the evaluation was stopped. This indicates that good battery performances are achieved within the range of 0.5≦x≦1.6.

### Examples 13-1 to 13-5

A secondary battery was produced as in example 11-8 except that the utilization factor of the negative electrode of the secondary battery was changed as shown in Table 13. The cutoff voltage of the negative electrode and the volume density of the negative electrode active material at charging were changed accordingly as shown in Table 13.

The cycle performance and the first charge and discharge performance of the secondary batteries in examples 13-1 to 13-5 were investigated. The result is given in Table 13.

TABLE 13

| | Volume | Negative | | | |
|---|---|---|---|---|---|
| | density | electrode | Negative | | Initial |
| | at | cutoff | electrode | Capacity | effi- |
| | charging | voltage | utilization | retention | ciency |
| | (g/cc) | (V) | factor (%) | rate (%) | (%) |
| Example 13-1 | 1.11 | 0.89 | 90 | 89 | 84.6 |
| Example 13-2 | 1.11 | 0.91 | 92 | 87.8 | 85.0 |
| Example 13-3 | 1.13 | 0.93 | 93 | 87.5 | 85.5 |
| Example 13-4 | 1.16 | 0.96 | 97 | 86.7 | 86.1 |
| Example 13-5 | 1.18 | 0.97 | 99 | 86.4 | 86.4 |

The batteries having a negative electrode utilization factor of 93% or more (examples 13-3 to 13-5) increased the initial efficiency and thus significantly improved the battery capacity more than those of the batteries having a negative electrode utilization factor of less than 93% (examples 13-1 and 13-2).

A battery having a negative electrode utilization factor of 100% can increase the battery capacity, but it is feared that lithium is precipitated depending on design. Thus, the examination is preferably conducted with a maximum utilization factor of 99%. The examination demonstrated that the negative electrode utilization factor was preferably 93% or more and 99% or less when the increase in the battery capacity was considered.

### Examples 14-1 and 14-2 and Comparative Example 14-1

A secondary battery was produced as in example 11-8 except that, in example 14-1, the silicon-based active material was coated with LiF and carbon layer, and in example 14-2, the silicon-based active material was coated with Li₂CO₃ and carbon layer. In comparative example 14-1, none of LiF, Li₂CO₃ and carbon layer were formed on the surface.

The cycle performance and the first charge and discharge performance of the secondary batteries in examples 14-1 and 14-2 and comparative example 14-1 were investigated. The result is given in Table 14.

TABLE 14

| | | Capacity | Initial |
|---|---|---|---|
| | Surface layer of | retention | efficiency |
| | SiO material | rate (%) | (%) |
| Comparative | — | 82.6 | 81.6 |
| example 14-1 | | | |
| Example 14-1 | LiF, C layer | 84.9 | 84.7 |
| Example 14-2 | Li₂CO₃, C layer | 86.1 | 85.0 |
| Example 11-8 | LiF, Li₂CO₃, C layer | 86.9 | 85.9 |

As shown in Table 14, when the silicon-based active material was coated with LiF, Li₂CO₃, and carbon layer, both the capacity retention rate and the initial efficiency were improved.

### Examples 15-1 to 15-6

A secondary battery was produced as in example 11-8 except that Si/SiO₂ components produced in the bulk were changed to increase or decrease the initial efficiency of SiO alone and change the ratio A/B, where A is a peak intensity of an Si region represented by a chemical shift value of −60 ppm to −100 ppm and B is a peak intensity of an SiO₂ region represented by a chemical shift value of −100 ppm to −150 ppm that are obtained from a ²⁹Si-MAS-NMR spectrum, as shown in Table 15. This ratio can be controlled by subjecting the SiO₂ region to a potential-controlled electrochemical Li-doping method.

The cycle performance and the first charge and discharge performance of the secondary batteries in examples 15-1 to 15-6 were investigated. The result is given in Table 15.

TABLE 15

| | SiO | | Negative | | Initial |
|---|---|---|---|---|---|
| | initial | | electrode | Capacity | effi- |
| | efficiency | A(Si)/ | cutoff | retention | ciency |
| | (%) | B(SiO₂) | voltage (V) | rate (%) | (%) |
| Example 11-8 | 80 | 2 | 0.95 | 86.9 | 85.9 |
| Example 15-1 | 65 | 0.3 | 1.07 | 82.0 | 78.5 |
| Example 15-2 | 70 | 0.4 | 1.04 | 83.0 | 81.0 |
| Example 15-3 | 73 | 0.8 | 1.03 | 84.0 | 82.6 |
| Example 15-4 | 75 | 1 | 1.02 | 86.0 | 83.5 |
| Example 15-5 | 90 | 2.5 | 0.65 | 87.2 | 85.5 |
| Example 15-6 | 95 | 3 | 0.39 | 88.0 | 86.6 |

As shown in Table 15, when the peak intensity B of the SiO₂ region of the chemical shift value obtained from the ²⁹Si-MAS-NMR spectrum was small, namely when A/B was 0.8 or more, high battery performances were achieved. This indicates that the initial efficiency of the battery can be improved by previously reducing the SiO₂ portion, which is a Li-reacting site, as well as the battery degradation with charging and discharging can be inhibited by the stable lithium compound in the bulk or on the surface.

Moreover, examples 15-2 to 15-6, in which the negative electrode has a cutoff voltage of 0.39 V to 1.06 V when the battery cutoff voltage is 2.5 V, had better battery performances than example 15-1.

### Examples 16-1 to 16-7

A secondary battery was produced as in example 11-8 except that the type of the carbon-based active material in the negative electrode active materials and the content (mass %) of natural graphite with respect to the total weight of the carbon-based active material were changed as shown in Table 16.

The cycle performance and the first charge and discharge performance of the secondary batteries in examples 16-1 to 16-7 were investigated. The result is given in Table 16.

TABLE 16

| | | Natural | Volume | | Initial |
|---|---|---|---|---|---|
| | Carbon-based | graphite | density at | Capacity | effi- |
| | active | content | charging | retention | ciency |
| | material | (mass %) | (g/cc) | rate (%) | (%) |
| Exam- | natural graphite | 100 | 1.15 | 86.9 | 85.9 |
| ple 11-8 | | | | | |
| Exam- | natural graphite: | 80 | 1.15 | 88.0 | 86.0 |
| ple 16-1 | synthetic graphite | | | | |
| Exam- | natural graphite: | 50 | 1.15 | 89.0 | 86.3 |
| ple 16-2 | synthetic graphite | | | | |
| Exam- | natural graphite: | 30 | 1.22 | 88.0 | 87.0 |
| ple 16-3 | synthetic graphite | | | | |
| Exam- | natural graphite: | 10 | 1.35 | 87.0 | 84.1 |
| ple 16-4 | synthetic graphite | | | | |
| Exam- | natural graphite: | 50 | 1.15 | 88.0 | 81.1 |
| ple 16-5 | hard carbon | | | | |
| Exam- | natural graphite: | 50 | 1.15 | 85.0 | 83.9 |
| ple 16-6 | soft carbon | | | | |
| Exam- | natural graphite: | 50 | 1.15 | 86.0 | 82.3 |
| ple 16-7 | hard carbon: | | | | |
| | synthetic graphite | | | | |

As shown in Table 16, the batteries having a natural graphite content of 30% or more exhibited higher initial efficiency and retention rate than the battery having a natural graphite content of less than 30% (example 16-4). Moreover, the battery performances were improved with the increase of the amount of synthetic graphite to be mixed. Synthetic graphite enables high initial efficiency and cycle performance. Thus, the battery performances are improved by mixing synthetic graphite with a natural graphite content of 30% or more (examples 16-1 to 16-3).

### Example 17-1

A secondary battery was produced as in example 11-8 except that CNT was not added to the negative electrode as a conductive additive.

The cycle performance and the first charge and discharge performance of the secondary battery in example 17-1 was investigated. The result is given in Table 17.

TABLE 17

| | | Capacity | Initial |
|---|---|---|---|
| | | retention | efficiency |
| | CNT | rate (%) | (%) |
| Example 11-8 | 1 mass % | 86.9 | 85.9 |
| Example 17-1 | None | 83.8 | 85.8 |

As shown in Table 17, when CNT was added, both the retention rate and the initial efficiency were improved. This indicates that addition of CNT to the negative electrode allowed an electric contact between the silicon-based active material and the carbon-based active material, thus improving the battery performances.

### Examples 18-1 to 18-6

A secondary battery was produced as in example 11-8 except that the crystallinities of the lithium silicate compound (Li₂SiO₃ and Li₄SiO₄) produced in the bulk of the silicon-based active material were changed. The crystallinity of the lithium silicate compound can be changed by a heat treatment under a non-atmospheric condition after insertion and extraction of lithium.

The cycle performance and the first charge and discharge performance of the secondary batteries in examples 18-1 to 18-6 were investigated. The result is given in Table 18.

TABLE 18

| | | | Capacity | Initial |
|---|---|---|---|---|
| | Li₂SiO₃ | Li₄SiO₄ | retention | efficiency |
| | crystallinity | crystallinity | rate (%) | (%) |
| Example 18-1 | amorphous | 0.15° | 81.0 | 85.9 |
| Example 18-2 | amorphous | 0.2° | 84.0 | 85.9 |
| Example 18-3 | amorphous | 1° | 85.0 | 85.9 |
| Example 18-4 | 0.4° | amorphous | 80.0 | 85.9 |
| Example 18-5 | 0.75° | amorphous | 83.5 | 85.9 |
| Example 18-6 | 1° | amorphous | 86.0 | 85.9 |
| Example 11-8 | amorphous | amorphous | 86.9 | 85.9 |

As the crystallinities of the lithium silicate compounds decreased, the capacity retention rate was improved. The reason is supposed to be that the compound with low crystallinity reduced the resistance in the active materials. Thus, the lithium silicate compound is preferably amorphous, for better battery performances are achieved.

(Examples 19-1 to 19-9) A secondary battery was produced as in example 11-8 except that the crystallinity of the silicon-based active material was changed. The crystallinity can be changed by a heat treatment under a non-atmospheric condition after insertion and extraction of lithium. Table 19 shows the half width of the silicon-based active materials in examples 19-1 to 19-9. Although example 19-9 exhibited a half width of 20° or more, this value was obtained by fitting with analysis software because the peak value was not obtained. The silicon-based active material in example 19-9 was substantially amorphous.

The cycle performance and the first charge and discharge performance of the secondary batteries in examples 19-1 to 19-9 were investigated. The result is given in Table 19.

TABLE 19

| | | | Capacity | Initial |
|---|---|---|---|---|
| | Half width 2θ | Crystallite | retention | efficiency |
| | (°) | size (nm) | rate (%) | (%) |
| Example 19-1 | 0.756 | 11.42 | 78.0 | 85.8 |
| Example 19-2 | 0.796 | 10.84 | 79.0 | 85.8 |
| Example 19-3 | 1.025 | 8.55 | 79.8 | 85.9 |
| Example 19-4 | 1.218 | 7.21 | 83.0 | 85.9 |
| Example 19-5 | 1.271 | 6.63 | 85.0 | 85.8 |
| Example 19-6 | 1.845 | 4.62 | 86.0 | 85.9 |
| Example 19-7 | 2.257 | 3.77 | 86.5 | 85.9 |
| Example 11-8 | 2.593 | 3.29 | 86.9 | 85.9 |
| Example 19-8 | 10.123 | 1.524 | 88.0 | 85.9 |
| Example 19-9 | 20.221 | 0 | 89.0 | 85.9 |

As shown in Table 19, the capacity retention rate and the initial efficiency changed in response to the variation in the crystallinity.

In particular, high capacity retention rate and high initial efficiency were obtained by low crystallinity materials with a half width (2θ) of 1.2° or more and a crystallite size of 7.5 nm or less, which is attributable to an Si(111) crystal face. The best battery performances were obtained when the material was amorphous.

### Examples 20-1 to 20-7

A secondary battery was produced as in example 11-8 except that the median size X of the carbon-based active material, the median size Y of the silicon-based active material, and X/Y were changed as shown in Table 20.

The cycle performance and the first charge and discharge performance of the secondary batteries in examples 20-1 to 20-7 were investigated. The result is given in Table 20.

TABLE 20

| | | | | Volume | | |
|---|---|---|---|---|---|---|
| | | | | density at | Capacity | Initial |
| | Median size | Median size | | charging | retention | efficiency |
| | Y (μm) | X (μm) | X/Y | (g/cc) | rate (%) | (%) |
| Example 11-8 | 4 | 20 | 5 | 1.15 | 86.9 | 85.9 |
| Example 20-1 | 4 | 16 | 4 | 1.17 | 87.0 | 85.1 |
| Example 20-2 | 4 | 12 | 3 | 1.19 | 86.9 | 85.0 |
| Example 20-3 | 4 | 8 | 2 | 1.23 | 86.5 | 83.7 |
| Example 20-4 | 4 | 4 | 1 | 1.25 | 86.0 | 82.8 |
| Example 20-5 | 4 | 2 | 0.5 | 1.3 | 82.1 | 80.9 |
| Example 20-6 | 8 | 4 | 0.5 | 1.23 | 80.2 | 81.0 |
| Example 20-7 | 8 | 16 | 2 | 1.26 | 84.5 | 85.0 |

As shown in Table 20, the carbon-based active material in the negative electrode active material layer is preferably equal to or larger than the silicon-based active material. When the silicon-based active material, which was expandable and contractible, was equal to or smaller than the carbon-based active material, breakage of the mixture layer could be prevented. When the carbon-based active material was larger than the silicon-based active material, the volume density of the negative electrode at charging, the initial efficiency, and thus the battery energy density were improved.

### Examples 21-1 to 21-12

A secondary battery was produced basically as in examples 1-1 to 1-6 except the following.

In examples 21-1 and 21-2, silicon material powder modified by a thermal doping method was used as the silicon-based active material. Moreover, in example 21-1, the content of the silicon-based active material (also referred to as SiO material content below) with respect to the negative electrode materials was 30 mass %. In example 21-2, the SiO material content was 50 mass %.

In examples 21-3 to 21-12, the bulk modification of the silicon-based active material was carried out by applying the mixture slurry of the carbon-based active material and the unmodified silicon-based active material to the negative electrode current collector (the metallic current collect) and then modifying the silicon-based active material in the mixture slurry applied to the negative electrode current collector. The method for modifying the silicon material applied to the negative electrode current collector was an electrochemical method in examples 21-3 to 21-9, a Li metal-sticking method in example 21-10, and a Li vapor deposition method in examples 21-11 and 21-12. The Li metal-sticking method may be to apply the mixture slurry to the negative electrode current collector, then stick a lithium metal foil thereon, press it lightly, and heat it at 200° C. under a vacuum environment to modify the silicon-based active material, although the method is not particularly limited to this procedure. Other examples of the Li metal-sticking method include a method in which the current collector on which a lithium metal foil has been stuck is immersed in an electrolyte and stored at 60° C. for about 1 week; and a method in which the current collector on which a lithium metal foil has been stuck is wound to produce a battery, and lithium is inserted into the silicon-based active material in the battery during initial charging.

Moreover, the SiO material content was 30 mass % in examples 21-3 to 21-6 and 21-11, 50 mass % in example 21-7, and 80 mass % in examples 21-8 to 21-10 and 21-12.

The cycle performance and the first charge and discharge performance of the secondary batteries in examples 21-1 to 21-12 were investigated. The result is given in Table 21.

TABLE 21

| | SiO | | | | | | | |
|---|---|---|---|---|---|---|---|---|
| | material | | | | | | Capacity | Initial |
| | content | | | Electrode | Modification | Modification | retention | efficiency |
| | (%) | A/B | Graphite | process | state | method | rate (%) | (%) |
| Example 1-4 | 30 | 2 | natural | application | powder | electro- | 87 | 83.1 |
| | | | graphite | | | chemical | | |
| Example 1-5 | 50 | 2 | natural | application | powder | electro- | 86.4 | 81.6 |
| | | | graphite | | | chemical | | |
| Example 1-6 | 80 | 2 | natural | application | powder | electro- | 86 | 80.0 |
| | | | graphite | | | chemical | | |
| Example 21-1 | 30 | 2 | natural | application | powder | thermal | 83 | 81.9 |
| | | | graphite | | | doping | | |
| Example 21-2 | 50 | 2 | natural | application | powder | thermal | 80 | 80.1 |
| | | | graphite | | | doping | | |
| Example 21-3 | 30 | 2 | synthetic | application | electrode | electro- | 89 | 84.5 |
| | | | graphite | | | chemical | | |
| Example 21-4 | 30 | 2.5 | synthetic | application | electrode | electro- | 89.5 | 91 |
| | | | graphite | | | chemical | | |
| Example 21-5 | 30 | 2 | natural | application | electrode | electro- | 88 | 83.5 |
| | | | graphite | | | chemical | | |
| Example 21-6 | 30 | 2.5 | natural | application | electrode | electro- | 89 | 90 |
| | | | graphite | | | chemical | | |
| Example 21-7 | 50 | 2.5 | natural | application | electrode | electro- | 91 | 89.5 |
| | | | graphite | | | chemical | | |
| Example 21-8 | 80 | 2 | natural | application | electrode | electro- | 80 | 80 |
| | | | graphite | | | chemical | | |
| Example 21-9 | 80 | 2.5 | natural | application | electrode | electro- | 90 | 88.8 |
| | | | graphite | | | chemical | | |
| Example 21-10 | 80 | 2 | natural | application | electrode | Li stacking | 79 | 78 |
| | | | graphite | | | | | |
| Example 21-11 | 30 | 2 | natural | application | electrode | Li vapor | 86 | 83 |
| | | | graphite | | | deposition | | |
| Example 21-12 | 80 | 2 | natural | application | electrode | Li vapor | 79 | 79 |
| | | | graphite | | | deposition | | |

As shown in Table 21, even when the silicon material powder was modified by the thermal doping method before applying to the negative electrode current collector like examples 21-1 and 21-2, the silicon material could be sufficiently modified so that good retention rate and initial efficiency were achieved. When the silicon-based active material was modified after applying the mixture slurry to the metallic current collector like examples 21-3 to 21-12, the retention rate and the initial efficiency were improved more greatly. Especially in the case that A/B ratio is significantly increased, the silicon-based active material is preferably modified by an electrochemical method after applying the mixture slurry to the metallic current collector. The electrochemical method enables a part of the SiO₂ components produced within the silicon-based active material to be selectively modified into a lithium compound more easily than the Li-sticking method or the Li vapor deposition method.

It is to be noted that the present invention is not restricted to the foregoing embodiment. The embodiment is just an exemplification, and any examples that have substantially the same feature and demonstrate the same functions and effects as those in the technical concept described in claims of the present invention are included in the technical scope of the present invention.

1-17. (canceled)

18. A negative electrode for a non-aqueous electrolyte secondary battery,
comprising a plurality of negative electrode active materials including at least a silicon-based active material expressed by SiOₓ where 0.5≦x≦1.6 and a carbon-based active material, the silicon-based active material containing at least one of Li₂SiO₃ and Li₄SiO₄ therein, the silicon-based active material being coated with at least one of Li₂CO₃, LiF, and carbon, the silicon-based active material being included in an amount of 6 mass % or more with respect to a total amount of the negative electrode active materials.

19. The negative electrode for a non-aqueous electrolyte secondary battery according to claim 18, wherein the negative electrode active materials have a volume density of 0.75 g/cc or more and 1.38 g/cc or less at charging.

20. The negative electrode for a non-aqueous electrolyte secondary battery according to claim 18, further comprising a carbon nanotube.

21. The negative electrode for a non-aqueous electrolyte secondary battery according to claim 18, wherein the carbon-based active material includes at least two of natural graphite, synthetic graphite, hard carbon, and soft carbon.

22. The negative electrode for a non-aqueous electrolyte secondary battery according to claim 18, wherein the carbon-based active material includes natural graphite in an amount of 30 mass % or more and 80 mass % or less with respect to a total weight of the carbon-based active material.

23. The negative electrode for a non-aqueous electrolyte secondary battery according to claim 18, wherein a median size X of the carbon-based active material and a median size Y of the silicon-based active material satisfy X/Y≧1.

24. The negative electrode for a non-aqueous electrolyte secondary battery according to claim 18, wherein the silicon-based active material satisfies A/B≧0.8 where A is a peak intensity of an Si region represented by a chemical shift value of −60 ppm to −100 ppm and B is a peak intensity of an SiO₂ region represented by a chemical shift value of −100 ppm to −150 ppm, the chemical shift value being obtained from a ²⁹Si-MAS-NMR spectrum.

25. The negative electrode for a non-aqueous electrolyte secondary battery according to claim 18, wherein Li₂SiO₃ contained inside the silicon-based active material exhibits a diffraction peak having a half width (2θ) of 0.75° or more, the diffraction peak appearing around 38.26800 and obtained by X-ray diffraction.

26. The negative electrode for a non-aqueous electrolyte secondary battery according to claim 18, wherein Li₄SiO₄ contained inside the silicon-based active material exhibits a diffraction peak having a half width (2θ) of 0.2° or more, the diffraction peak appearing around 23.9661° and obtained by X-ray diffraction.

27. The negative electrode for a non-aqueous electrolyte secondary battery according to claim 18, wherein Li₂SiO₃ and Li₄SiO₄ contained inside the silicon-based active material are amorphous.

28. The negative electrode for a non-aqueous electrolyte secondary battery according to claim 18, wherein the silicon-based active material exhibits a diffraction peak having a half width (2θ) of 1.2° or more, the diffraction peak being attributable to an Si(111) crystal face and obtained by X-ray diffraction, and a crystallite size attributable to the crystal face is 7.5 nm or less.

29. A non-aqueous electrolyte secondary battery comprising a negative electrode according to claim 18 and a positive electrode containing a positive electrode active material of lithium cobaltate, wherein the negative electrode has a discharge cutoff voltage of 0.35 V or more and 0.85 V or less when a battery cutoff voltage is 3 V.

30. A non-aqueous electrolyte secondary battery comprising a negative electrode according to claim 18 and a positive electrode containing a positive electrode active material of a lithium nickel cobalt complex oxide, wherein the negative electrode has a discharge cutoff voltage of 0.39 V or more and 1.06 V or less when a battery cutoff voltage is 2.5 V.

31. The non-aqueous electrolyte secondary battery according to claim 30, wherein the lithium nickel cobalt complex oxide is a lithium nickel cobalt aluminum complex oxide or a lithium nickel cobalt manganese complex oxide.

32. The non-aqueous electrolyte secondary battery according to claim 29, wherein a utilization factor of the negative electrode is 93% or more and 99% or less.

33. A method of producing a negative electrode for a non-aqueous electrolyte secondary battery, the negative electrode containing a negative electrode active material and a metallic current collector, the method comprising:
preparing, as the negative electrode active material, a carbon-based active material and an unmodified silicon-based active material expressed by SiOₓ where 0.5≦x≦1.6;
forming a mixture slurry of the carbon-based active material and the unmodified silicon-based active material that have been prepared;
applying the formed mixture slurry to the metallic current collector; and
after applying, modifying the silicon-based active material in the mixture slurry applied to the metallic current collector by at least one of a Li metal-sticking method, a Li vapor deposition method, and an electrochemical method.

34. A negative electrode for a non-aqueous electrolyte secondary battery produced by the method according to claim 33.
